(19) United States
(12) Patent Application Publication
(10) Pub. No.: US 2026/0365838 A1
(43) Pub. Date: Nov. 19, 2026

(54) RECYCLATE CONTAINING POLYPROPYLENE COMPOSITION FOR INTERIOR AUTOMOTIVE APPLICATIONS

(71) Applicant: BOREALIS GMBH, Vienna (AT)

(72) Inventors: Daniela Mileva, Linz (AT); Markus Gall, Linz (AT); Wolfgang Stockreiter, Linz (AT); Christophe Salles, Paris (FR)

(21) Appl. No.: 19/490,491

(22) PCT Filed: Jun. 6, 2024
(86) PCT No.: PCT/EP2024/065580

§ 371 Date: Dec. 5, 2025

(30) Foreign Application Priority Data
Jun. 7, 2023 (EP) 23178131.1

(51) Int. Cl. C08L 23/12; C08K 3/34

(52) U.S. Cl. CPC C08L 23/12; C08K 3/346; C08K 2201/005; C08L 2205/03; C08L 2207/20

(57) ABSTRACT

The present invention relates to a polypropylene composition (PC) being a mixed plastic polypropylene blend containing recycled material and comprising inclusions attributed to automotive paints and to articles comprising said polypropylene composition (PC).

The present invention relates to a polypropylene composition (PC) being a mixed-plastic polypropylene blend containing recycled material and comprising inclusions attributed to automotive paints and to articles comprising said polypropylene composition (PC).

### TECHNICAL BACKGROUND

Compositions suitable for the automotive industry typically contain one or more heterophasic polypropylene copolymer(s), and/or random heterophasic copolymers, and conventionally some inorganic filler.

There are two trends in the automotive industry:
Weight reduction demanding thin-wall constructions and the need to keep mineral reinforcements at a low level.
Use of post-industrial and even post-consumer recyclate material of lower MFR and limited impact strength, requiring a boost by other components in the final composition.

PCT/EP2022/084506 discloses polypropylene compositions in which up to 35.0 wt.-% of a recyclate blend originating from post-consumer waste is used, which shows a good balance of properties in regard of mechanical properties, low emissions and excellent surface properties is obtained, which is especially suitable for interior automotive applications. Said polypropylene compositions contain up to 20.0 wt.-% inorganic filler and up to 15.0 wt.-% of ethylene-1-octene elastomer.

It has surprisingly been found that when replacing the recyclate blend originating from post-consumer waste with a recyclate blend originating from post-consumer waste from very special sources, preferably from end-of life vehicle (ELV) recycled feedstock, a comparable balance of properties as in PCT/EP2022/084506 can be achieved with a higher weight content of recyclate blend originating from post-consumer waste, preferably from end-of life vehicle (ELV) recycled feedstock and lower contents of inorganic filler and ethylene-1-octene elastomer.

Thus, the present invention is based in the surprising finding of providing a polypropylene composition with a high weight content of recyclate blend and low contents of inorganic filler and ethylene-1-octene elastomer, which shows a good balance of properties in regard of mechanical properties, low emissions and excellent surface properties. Additionally, the inventive polypropylene compositions show a high toughness after processing and show a low coefficient of linear thermal expansion (CLTE).

The polypropylene compositions according to the invention are therefore especially suitable for interior automotive applications.

### SUMMARY OF THE INVENTION

Therefore, in a first aspect, the present invention is directed, in its broadest sense, to a polypropylene composition (PC) being a mixed-plastic polypropylene blend, wherein the polypropylene composition (PC) comprises:
inclusions attributed to automotive paints, determined on compressed films with a thickness of 35 to 70 μm, wherein the inclusions are identified by optical microscopy, the chemical composition of the inclusions is characterized by infrared spectroscopy and the physical information of the inclusions is characterized by computed tomography; and
a content of low boiling organic substances (LBS), determined by screening of organic emissions by thermos-desorption analysis of not more than 100 μg/g;
wherein the polymeric part of said polypropylene composition (PC) has:
   i) an ethylene content (C2(total)), determined from crystallization extraction (CRYSTEX) by FT-IR spectroscopy calibrated by quantitative ¹³C-NMR spectroscopy, in the range from 7.5 to 35.0 wt.-%;
   ii) a crystalline fraction (CF) content, determined by crystallization extraction (CRYSTEX) analysis, in the range from 60.0 to 80.0 wt.-%, said crystalline fraction (CF) having an ethylene content (C2(CF)), determined by FT-IR spectroscopy calibrated by quantitative ¹³C-NMR spectroscopy, in the range from 1.0 to 15.0 wt.-%, and
   an intrinsic viscosity (iV(CF)), determined according to DIN ISO 1628/1, in the range from 1.00 to 2.00 dL/g; and
   iii) a soluble fraction (SF) content, determined by crystallization extraction (CRYSTEX) analysis, in the range from 20.0 to 40.0 wt.-%, said soluble fraction (SF) having
   an intrinsic viscosity (iV(SF)), determined according to DIN ISO 1628/1, in the range from 1.80 to 3.60 dL/g.

It is preferred that the polypropylene composition (PC) is obtainable by blending at least components a) to h):
a) from 1.0 to 40.0 wt.-%, relative to the total weight of the polypropylene composition (PC), of a first heterophasic propylene-ethylene copolymer (HECO1), having a melt flow rate (MFR₂), determined according to ISO 1133 at 230 °C and 2.16 kg, in the range from 90 to 250 g/10 min and an intrinsic viscosity, determined according to DIN ISO 1628/1, of the soluble fraction (iV(SF)), according to crystallization extraction (CRYSTEX) analysis, in the range from 2.00 to 4.00 dL/g;
b) from 0.0 to 35.0 wt.-%, relative to the total weight of the of the polypropylene composition (PC), of a second heterophasic propylene-ethylene copolymer (HECO2), having a melt flow rate (MFR₂), determined according to ISO 1133 at 230 °C and 2.16 kg, in the range from 3.0 to 30 g/10 min and an intrinsic viscosity, determined according to DIN ISO 1628/1, of the soluble fraction (iV(SF)), according to crystallization extraction (CRYSTEX) analysis, in the range from 4.10 to 10.00 dL/g;
c) from 0.0 to 35.0 wt.-%, relative to the total weight of the polypropylene composition (PC), of a third heterophasic propylene-ethylene copolymer (HECO3), having a melt flow rate (MFR₂), determined according to ISO 1133 at 230 °C and 2.16 kg, in the range from 5.0 to 30 g/10 min and an intrinsic viscosity, determined according to DIN ISO 1628/1, of the soluble fraction (iV(SF)), according to crystallization extraction (CRYSTEX) analysis, in the range from 2.00 to 4.00 dL/g;
d) from 7.5 to 85.0 wt.-%, relative to the total weight of the polypropylene composition (PC), of a mixed-plastic polypropylene blend (B) comprising inclusions attributed to automotive paints, determined on compressed films with a thickness of 35 to 70 μm, wherein the inclusions are identified by optical microscopy, the chemical composition of the inclusions is characterized by infrared spectroscopy and the physical information of the inclusions is characterized by computed tomography;
e) from 0 to 7.5 wt.-% of an ethylene-1-octene elastomer (EC);
f) from 0 to 25.0 wt.-% of an inorganic filler (F);
g) from 0.5 to 10.0 wt.-% of a pigment masterbatch (P), which comprises one or more pigments, wherein the total pigment content is in the range from 40.0 to 80.0 wt.-%, relative to the total weight of the pigment masterbatch (P); and
h) from 0.2 to 5.0 wt.-% of further additives (A);

wherein the total contents of components a) to h) add up to at least 95 wt.-%, more preferably at least 98 wt.-%, most preferably 100 wt.-%, relative to the total weight of the polypropylene composition (PC).

In a further aspect, the present invention is directed to an article, preferably an injection-moulded article, comprising the polypropylene composition of the first aspect in an amount of at least 95 wt.-%, more preferably at least 98 wt.-%, most preferably at least 99 wt.-%.

### DEFINITIONS

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a,” “an,” and the like refers to one or more.

In the following, amounts are given in % by weight (wt.-%) unless it is stated otherwise.

A propylene homopolymer is a polymer that essentially consists of propylene monomer units. Due to impurities especially during commercial polymerization processes, a propylene homopolymer can comprise up to 0.1 mol % comonomer units, preferably up to 0.05 mol % comonomer units and most preferably up to 0.01 mol % comonomer units.

A propylene copolymer is a copolymer of propylene monomer units and comonomer units, preferably selected from ethylene and C₄-C₈ alpha-olefins. A propylene random copolymer is a propylene copolymer wherein the comonomer units are randomly distributed along the polymer chain, whilst a propylene block copolymer comprises blocks of propylene monomer units and blocks of comonomer units. Propylene random copolymers can comprise comonomer units from one or more comonomers different in their amounts of carbon atoms.

The heterophasic propylene copolymers typically comprise:
a) a crystalline propylene homopolymer or copolymer matrix (M); and
b) an elastomeric rubber, preferably a propylene-ethylene copolymer (E);

In case of a random heterophasic propylene copolymer, said crystalline matrix phase is a random copolymer of propylene and at least one alpha-olefin comonomer.

The elastomeric phase can be a propylene copolymer with a high amount of comonomer that is not randomly distributed in the polymer chain but is distributed in a comonomer-rich block structure and a propylene-rich block structure. A heterophasic polypropylene usually differentiates from a one-phasic propylene copolymer in that it shows two distinct glass transition temperatures Tg which are attributed to the matrix phase and the elastomeric phase.

The presence of a heterophasic nature can be easily determined by the number of glass transition points, like in dynamic-mechanical analysis (DMA), and/or high resolution microscopy, like scanning electron microscopy (SEM), transmission electron microscopy (TEM) or atomic force microscopy (AFM).

A polypropylene means a polymer being composed of units derived from propylene in an amount of more than 50 mol-%.

A polyethylene means a polymer being composed of units derived from ethylene in an amount of more than 50 mol-%.

The term “elastomer” denotes a natural or synthetic polymer having elastic properties. The term “plastomer” denotes a natural or synthetic polymer, which combines qualities of elastomers and plastics, such as rubber-like properties with the processing ability of plastic. An ethylene based plastomer means a plastomer being composed of units derived from ethylene in an amount of more than 50 mol-%.

For the purposes of the present description and of the subsequent claims, the term “recycled waste” is used to indicate a material recovered from post-consumer waste only, as opposed to virgin polymers and material recovered from post industrial waste. Post-consumer waste refers to objects having completed at least a first use cycle (or life cycle), i.e. having already served their first purpose; while post-industrial waste refers to manufacturing scrap, which does not normally reach a consumer. The term “recycled waste” is especially used for mixed-plastics waste collected from end-of live (ELV) vehicles, especially from end-of-life (ELV) car bumpers.

The term “virgin” denotes the newly produced materials and/or objects prior to their first use, which have not already been recycled. In case that the origin of the polymer is not explicitly mentioned the polymer is a “virgin” polymer.

The term “recycled material” such as used herein denotes materials reprocessed from “recycled waste”.

A polymer blend denotes a mixture of two or more polymeric components. In general, the blend can be prepared by mixing the two or more polymeric components. Suitable mixing procedures known in the art are post-polymerization blending procedures. Post-polymerization blending can be dry blending of polymeric components such as polymer powders and/or compounded polymer pellets or melt blending by melt mixing the polymeric components.

A mixed-plastic polypropylene blend indicates that the blend predominantly comprises polypropylene; however, small amounts of other plastic are present. In the present invention a mixed-plastic polypropylene blend is preferably used, which results from post-consumer waste from very special sources, which is characterized by the presence of inclusions attributed to automotive paints, preferably post-consumer waste from end-of-live (ELV) vehicles, more preferably from end-of-life (ELV) car bumpers. The presence of such mixed-plastic polypropylene blends can be identified in a polypropylene composition by identifying inclusions attributed to automotive paints e.g. by means of IR spectroscopy in the polypropylene composition.

The term “inclusions attributed to automotive paints” means particles, which comprise chemical components, which originate from automotive paints, such as styrene-based components, urethane-based components and/or acrylic-based components. Said components in the polypropylene composition usually originate from paint residuals in the mixed-plastic polypropylene blend (B) contained in the polypropylene composition. The inclusions are usually identified by optical microscopy on compressed films of the polypropylene composition and are identified as “inclusions attributed to automotive paints” by characterizing their chemical composition and their physical information. The chemical composition of said inclusions can be determined by IR spectroscopy. Thereby, the IR sprectra show characteristic bands which can be attributed to styrene-based components and/or urethane-based components and/or acrylic based components, such as e.g. at 700 cm⁻¹ and 760 cm⁻¹, which indicate styrene modifications, at 3380 cm⁻¹, which indicates OH, NH stretching of acrylate or urethane, and/or at 1700 cm⁻¹, which indicates C═O stretching of acrylate or urethane. The shape and other physical information of the particles can be characterized by computed tomography. The inclusions usually show a sharp edged and platelet-like 3D shape, usually with a multilayer structure, and a grey value, which is at least 50% higher compared to the average grey value of the surrounding polypropylene composition and therefore differentiates from other inclusions such as pigment particles or talc particles, which have a rounder 3D shape or have smooth edges or show grey values below the threshold of at least 50% higher compared to the average grey value of the surrounding polypropylene composition. The measurement method is described in the example section. Said inclusions are specific to post-consumer waste from very special sources, such as post-consumer waste from end-of-live (ELV) vehicles, more preferably from end-of-life (ELV) car bumpers, and are not found in other sorts of post-consumer waste e.g. from household waste.

The present invention will now be described in more detail.

### DETAILED DESCRIPTION

### Polypropylene Composition (PC)

The present invention is directed, in a first aspect, to a polypropylene composition (PC) being a mixed-plastic polypropylene blend.

The polypropylene composition (PC) is characterized by the presence of inclusions attributed to automotive paints. Said inclusions are detemined in the example section on compressed films with a thickness of 35 to 70 μm, wherein the inclusions are identified by optical microscopy, the chemical composition of the inclusions is characterized by infrared spectroscopy and the physical information of the inclusions is characterized by computed tomography.

The polypropylene composition (PC) further has a content of low boiling organic substances (LBS) determined by screening of organic emissions by thermo-desorption analysis of not more than 100 μg/g, such as in the range from 5 to 100 μg/g, preferably in the range from 5 to 80 μg/g, most preferably in the range from 5 to 75 μg/g.

Still further, the polypropylene composition (PC) preferably has a content of acetaldehyde of not more than 50 mg/m³, more preferably not more than 40 mg/m³. The lower limit is usually at least 5 mg/m³, preferably at least 10 mg/m³. Acetaldehyde is the most significant odour marker. Such a low amount of acetaldehyde indicates the suitability of the polypropylene composition (PC) for interior automotive applications.

The polypropylene composition (PC) preferably has a content of high boiling organic substances (HBS) determined by screening of organic emissions by thermo-desorption analysis in the range from 10 to 300 μg/g, more preferably in the range from 20 to 280 μg/g, most preferably in the range from 30 to 250 μg/g.

The polypropylene composition (PC) preferably has an amount of fogging, determined according to the gravimetric method DI 75201:2011-11, method B, in the range from 0.05 to 1.00 mg, more preferably in the range from 0.10 to 0.80 mg, most preferably in the range from 0.10 to 0.75 mg.

Further, the polypropylene composition (PC) usually has a low limonene content, determined by solid phase microextraction (HS-SPME-GC-MS). Usually the limonene content in the polypropylene composition is less than 0.1 ppm. In some embodiments, the limonene content is even below the detection limit of the HS-SPME-GC-MS method. The low limonene content in these embodiments results from the use of mixed-plastic polypropylene blends (B) which themselves only contain traces of limonene as they do not originate from post-consumer household waste.

However, in some embodiments the mixed-plastic polypropylene blends (B) include recycled blends, which in an earlier life cycle originate from post-consumer household waste typically in amounts of up to 50 wt.-%, based on the total amounts of mixed plastic polypropylene blends (B). In said embodiments the polypropylene composition (PC) can contain a limonene content, determined by solid phase microextraction (HS-SPME-GC-MS) an amount of not more than 5.0 ppm, such as in the range of 0.05 to 5.0 ppm.

The polypropylene composition (PC) preferably has a melt flow rate (MFR₂), determined according to ISO 1133 at 230 °C and 2.16 kg, in the range from 5.0 to 50.0 g/10 min, more preferably in the range from 7.5 to 35.0 g/10 min, most preferably in the range from 9.0 to 25.0 g/10 min.

Further, the polypropylene composition (PC) preferably has a flexural modulus, determined according to ISO 178 using 80×10×4 mm³ test bars injection-moulded in line with ISO 19069-2, in the range from 900 to 2500 MPa, more preferably in the range from 1000 to 2300 MPa, most preferably in the range from 1250 to 2250 MPa.

The polypropylene composition (PC) preferably has a Charpy Notched impact strength at 23 °C, determined according to ISO 179 using 80×10×4 mm³ test bars injection-moulded in line with ISO 19069-2, in the range from 10.0 to 70.0 kJ/m², more preferably in the range from 13 to 60 kJ/m², most preferably in the range from 15 to 55 kJ/m².

The polypropylene composition (PC) preferably has a Charpy Notched impact strength at −20 °C, determined according to ISO 179 using 80×10×4 mm³ test bars injection-moulded in line with ISO 19069-2, in the range from 2.5 to 12.0 kJ/m², more preferably in the range from 3.0 to 10.0 kJ/m², most preferably in the range from 3.5 to 7.5 kJ/m².

The polymeric part of the polypropylene composition (PC) may be characterized according to the crystallization extraction (CRYSTEX) method using trichlorobenzene (TCB) as a solvent. This method is described below in the determination methods section. The crystalline fraction (CF) contains for the most part the matrix phase and only a small part of the elastomeric phase and the soluble fraction (SF) contains for the most part the elastomeric phase and only a small part of the matrix phase. In some cases, this method results in more useful data, since the crystalline fraction (CF) and the soluble fraction (SF) more accurately correspond to the matrix and elastomeric phases respectively. Due to the differences in the separation methods of xylene extraction and crystallization extraction (CRYSTEX) method the properties of XCS/XCI fractions on the one hand and crystalline/soluble (CF/SF) fractions on the other hand are not exactly the same, meaning that the amounts of matrix phase and elastomeric phase can differ as well as the properties.

Generally, the crystalline fraction (CF) content and the soluble (SF) content of a composition only relate to its polymeric components, i.e. without other components, which are insoluble and therefore not part of the dissolution and crystallization cycles as described below in the determination method, such as the inorganic filler (F).

The crystalline fraction (CF) content and the soluble (SF) content therefore are based on the weight amount of the polymeric components of the polypropylene composition (PC).

The polymeric part of the polypropylene composition (PC) has an ethylene content (C2(total)), determined from crystallization extraction (CRYSTEX) by FT-IR spectroscopy calibrated by quantitative ¹³C-NMR spectroscopy, in the range from 7.5 to 35.0 wt.-%, preferably in the range from 10.0 to 30.0 wt.-%, most preferably in the range from 12.0 to 22.0 wt.-%.

The polymeric part of the polypropylene composition (PC) preferably has an intrinsic viscosity (iV(total)), determined from crystallization extraction (CRYSTEX) according to DIN ISO 1628/1, in the range from 1.00 to 2.50 dL/g, more preferably in the range from 1.20 to 2.30 dL/g, most preferably in the range from 1.40 to 2.20 dL/g.

The polymeric part of the polypropylene composition (PC) has a soluble fraction (SF) content, determined by crystallization extraction (CRYSTEX) analysis, in the range from 20.0 to 40.0 wt.-%, more preferably in the range from 20.0 to 35.0 wt.-%, most preferably in the range from 20.0 to 30.0 wt.-%

Said soluble fraction (SF) preferably has an ethylene content (C2(SF)) determined by FT-IR spectroscopy calibrated by quantitative ¹³C-NMR spectroscopy, in the range from 25.0 to 70.0 wt.-%, more preferably in the range from 30.0 to 65.0 wt.-%, still more preferably in the range from 35.0 to 60.0 wt.-%, most preferably in the range from 40.0 to 58.0 wt.-%.

Said soluble fraction (SF) also has an intrinsic viscosity (iV(SF)), determined according to DIN ISO 1628/1, in the range from 1.80 to 3.60 dL/g, more preferably in the range from 1.90 to 3.30 dL/g, most preferably in the range from 2.00 to 3.00 dL/g.

The polymeric part of the polypropylene composition (PC) has a crystalline fraction (CF) content, determined by crystallization extraction (CRYSTEX) analysis, in the range from 60.0 to 80.0 wt.-%, more preferably in the range from 65.0 to 80.0 wt.-%, most preferably in the range from 70.0 to 80.0 wt.-%

Said crystalline fraction (CF) has an ethylene content (C2(CF)) determined by FT-IR spectroscopy calibrated by quantitative ¹³C-NMR spectroscopy, in the range from 1.0 to 15.0 wt.-%, preferably in the range from 2.0 to 15.0 wt.-%, more preferably in the range from 2.5 to 15.0 wt.-%, most preferably in the range from 3.0 to 10.0 wt.-%.

Said crystalline fraction (CF) also has an intrinsic viscosity (iV(CF)), determined according to DIN ISO 1628/1, in the range from 1.00 to 2.00 dL/g, more preferably in the range from 1.20 to 1.90 dL/g, most preferably in the range from 1.30 to 1.80 dL/g.

The polypropylene composition (PC) preferably comprises
a) from 5.0 to 65.0 wt.-%, preferably from 6.0 to 62.5 wt.-%, more preferably from 15.0 to 62.0 wt.-%, still more preferably from 25.0 to 62.0 wt.-% of heterophasic propylene-ethylene copolymer (HECO);
b) from 7.5 to 85.0 wt.-%, preferably from 9.0 to 82.5 wt.-%, more preferably from 10.0 to 50.0 wt.-%, still more preferably from 15.0 to 45.0 wt.-% of a mixed-plastic polypropylene blend (B) comprising inclusions attributed to automotive paints;
c) from 0 to 7.5 wt.-%, preferably from 0 to 6.5 wt.-% of ethylene-1-octene elastomer (EC);
d) from 0 to 25.0 wt.-%, preferably from 0 to 21.0 wt.-% of an inorganic filler (F);
e) from 0.5 to 10.0 wt.-%, preferably from 2.0 to 10.0 wt.-% of a pigment masterbatch (P), which comprises one or more pigments, wherein the total pigment content is in the range from 40.0 to 80.0 wt.-%, relative to the total weight of the pigment masterbatch (P); and
f) from 0.2 to 5.0 wt.-% of further additives (A),

wherein the total contents of components a) to f) add up to at least 95 wt.-%, more preferably at least 98 wt.-%, most preferably 100 wt.-%, relative to the total weight of the polypropylene composition (PC).

These components are typically analyzable from the resulting polypropylene composition (PC).

The polypropylene composition (PC) preferably comprises
i. from 40.0 to 75.0 wt.-%, preferably from 45.0 to 72.5 wt.-% of a total amount of heterophasic propylene-ethylene copolymer;
ii. from 10.0 to 25.0 wt.-%, preferably from 15.0 to 22.5 wt.-% of a total amount of an ethylene-based elastomer;
iii. from 0.5 to 30.0 wt.-%, preferably from 0.5 to 27.5 wt.-% of a total amount of inorganic filler;
iv. from from 0.5 to 10.0 wt.-%, preferably from 2.0 to 10.0 wt.-% of a pigment masterbatch (P), which comprises one or more pigments, wherein the total pigment content is in the range from 40.0 to 80.0 wt.-%, relative to the total weight of the pigment masterbatch (P); and
v. from 0.2 to 5.0 wt.-% of further additives (A),

wherein the total contents of components i. to v. add up to at least 95 wt.-%, more preferably at least 98 wt.-%, most preferably 100 wt.-%, relative to the total weight of the polypropylene composition (PC).

The components i. to iii. preferably result from virgin polymers and inorganic fillers and polymers and inorganic fillers, which are added in form of a mixed-plastics blend, such as mixed-plastic polypropylene blend (B).

These components are typically analyzable from the resulting polypropylene composition (PC).

The ethylene-based elastomer is preferably copolymer of ethylene with a comonomer selected from alpha olefin comonomer(s) having from 3 to 10 carbon atoms. The ethylene-based elastomer can be a mixture of copolymers of ethylene with different comonomers selected from alpha olefin comonomer(s) having from 3 to 10 carbon atoms.

The polypropylene composition (PC) is preferably obtainable by blending at least components a) to h):
a) from 1.0 to 40.0 wt.-%, relative to the total weight of the polypropylene composition (PC), of a first heterophasic propylene-ethylene copolymer (HECO1);
b) from 0 to 35.0 wt.-%, relative to the total weight of the of the polypropylene composition (PC), of a second heterophasic propylene-ethylene copolymer (HECO2);
c) from 0 to 35.0 wt.-%, relative to the total weight of the of the polypropylene composition (PC), of a third heterophasic propylene-ethylene copolymer (HECO3);
d) from 7.5 to 85.0 wt.-%, relative to the total weight of the polypropylene composition (PC), of a mixed-plastic polypropylene blend (B) comprising inclusions attributed to automotive paints;
e) from 0 to 7.5 wt.-% of an ethylene-octene elastomer (EC);
f) from 0 to 25.0 wt.-% of an inorganic filler (F);
g) from 0.5 to 10.0 wt.-% of a pigment masterbatch (P); and
h) from 0.2 to 5.0 wt.-% of further additives (A).

The properties of each of these components are given in the respective sections below.

The total contents of components a) to h) add up to at least 95 wt.-%, more preferably at least 98 wt.-%, most preferably 100 wt.-%, relative to the total weight of the polypropylene composition (PC).

More preferably, the polypropylene composition (PC) is obtainable by blending at least components a) to h):
a) from 2.5 to 35.0 wt.-%, relative to the total weight of the polypropylene composition (PC), of a first heterophasic propylene-ethylene copolymer (HECO1);
b) from 2.5 to 35.0 wt.-%, relative to the total weight of the of the polypropylene composition (PC), of a second heterophasic propylene-ethylene copolymer (HECO2);
c) 0 wt.-%, relative to the total weight of the of the polypropylene composition (PC), of a third heterophasic propylene-ethylene copolymer (HECO3);
d) from 9.0 to 82.5 wt.-%, relative to the total weight of the polypropylene composition (PC), of a mixed-plastic polypropylene blend (B) comprising inclusions attributed to automotive paints;
e) from 0 to 6.5 wt.-% of an ethylene-octene elastomer (EC);
f) from 0 to 21.0 wt.-% of an inorganic filler (F);
g) from 2.0 to 10.0 wt.-% of a pigment masterbatch (P); and
h) from 0.2 to 5.0 wt.-% of further additives (A).

Still more preferably, the polypropylene composition (PC) is obtainable by blending at least components a) to h):
a) from 7.5 to 35.0 wt.-%, relative to the total weight of the polypropylene composition (PC), of a first heterophasic propylene-ethylene copolymer (HECO1);
b) from 7.5 to 35.0 wt.-%, relative to the total weight of the of the polypropylene composition (PC), of a second heterophasic propylene-ethylene copolymer (HECO2);
c) 0 wt.-%, relative to the total weight of the of the polypropylene composition (PC), of a third heterophasic propylene-ethylene copolymer (HECO3);
d) from 10.0 to 50.0 wt.-%, relative to the total weight of the polypropylene composition (PC), of a mixed-plastic polypropylene blend (B) comprising inclusions attributed to automotive paints;
e) from 0 to 6.5 wt.-% of an ethylene-octene elastomer (EC);
f) from 0 to 21.0 wt.-% of an inorganic filler (F);
g) from 2.0 to 10.0 wt.-% of a pigment masterbatch (P); and
h) from 0.2 to 5.0 wt.-% of further additives (A).

Even more preferably, the polypropylene composition (PC) is obtainable by blending at least components a) to h):
a) from 10.0 to 35.0 wt.-%, relative to the total weight of the polypropylene composition (PC), of a first heterophasic propylene-ethylene copolymer (HECO1);
b) from 10.0 to 35.0 wt.-%, relative to the total weight of the of the polypropylene composition (PC), of a second heterophasic propylene-ethylene copolymer (HECO2);
c) 0 wt.-%, relative to the total weight of the of the polypropylene composition (PC), of a third heterophasic propylene-ethylene copolymer (HECO3);
d) from 15.0 to 45.0 wt.-%, relative to the total weight of the polypropylene composition (PC), of a mixed-plastic polypropylene blend (B) comprising inclusions attributed to automotive paints;
e) from 0 to 6.5 wt.-% of an ethylene-octene elastomer (EC);
f) from 0 to 21.0 wt.-% of an inorganic filler (F);
g) from 2.0 to 10.0 wt.-% of a pigment masterbatch (P); and
h) from 0.2 to 5.0 wt.-% of further additives (A).

The blending of the polypropylene composition (PC) may be carried out according to a process comprising the steps of:
a) providing the first heterophasic propylene-ethylene copolymer (HECO1), the optional second heterophasic propylene-ethylene copolymer (HECO2), the optional third heterophasic propylene-ethylene copolymer (HECO3), the mixed-plastic polypropylene blend (B), the ethylene-octene elastomer (EC), the inorganic filler (F), the optional pigment masterbatch and the further additives (A);
b) blending and extruding the first heterophasic propylene-ethylene copolymer (HECO1), the optional second heterophasic propylene-ethylene copolymer (HECO2), the optional third heterophasic propylene-ethylene copolymer (HECO3), the mixed-plastic polypropylene blend (B), the ethylene-octene elastomer (EC), the inorganic filler (F), the optional pigment masterbatch and the further additives (A) at a temperature in the range from 120 to 250 °C in an extruder, preferably a twin-screw extruder, thereby generating the polypropylene composition (PC), preferably in pellet form.

In particular, it is preferred to use a conventional compounding or blending apparatus, e.g. a Banbury mixer, a 2-roll rubber mill, Buss-co-kneader or a twin-screw extruder. More preferably, mixing is accomplished in a co-rotating twin-screw extruder. The polymer materials recovered from the extruder are usually in the form of pellets.

The properties of the individual components will now be detailed in the following sections.

### First Heterophasic Propylene-Ethylene Copolymer (HECO1)

The first heterophasic propylene ethylene copolymer (HECO1) is preferably provided in an amount in the range from 1.0 to 40.0 wt.-%, more preferably in the range from 2.5 to 35.0 wt.-%, relative to the total weight of the polypropylene composition (PC).

The first heterophasic propylene ethylene copolymer (HECO1) has a melt flow rate (MFR₂), determined according to ISO 1133 at 230 °C and 2.16 kg, in the range from 90 to 250 g/10 min, more preferably in the range from 93 to 200 g/10 min, most preferably in the range from 95 to 150 g/10 min.

The first heterophasic propylene ethylene copolymer (HECO1) preferably has a soluble fraction (SF) content, determined by crystallization extraction (CRYSTEX) analysis, in the range from 8.0 to 19.5 wt.-%, more preferably in the range from 10.0 to 18.0 wt.-%, most preferably in the range from 13.0 to 17.0 wt.-%.

The first heterophasic propylene ethylene copolymer (HECO1) preferably has an ethylene content of the soluble fraction (C₂ (SF)), according to crystallization extraction (CRYSTEX) analysis, determined by FT-IR spectroscopy calibrated by quantitative ¹³C-NMR spectroscopy, in the range from 31.0 to 45.0 wt.-%, more preferably in the range from 33.0 to 43.0 wt.-%, most preferably in the range from 36.0 to 42.0 wt.-%.

The first heterophasic propylene ethylene copolymer (HECO1) has an intrinsic viscosity, determined according to DIN ISO 1628/1, of the soluble fraction (iV(SF)), according to crystallization extraction (CRYSTEX) analysis, in the range from 2.00 to 4.00 dL/g, more preferably in the range from 2.30 to 3.70 dL/g, most preferably in the range from 2.50 to 3.30 dL/g.

### Second Heterophasic Propylene-Ethylene Copolymer (HECO2)

The second heterophasic propylene ethylene copolymer (HECO2) is preferably provided in an amount in the range from 0 to 35.0 wt.-%, more preferably in the range from 2.5 to 35.0 wt.-%, relative to the total weight of the polypropylene composition (PC).

The second heterophasic propylene ethylene copolymer (HECO2) has a melt flow rate (MFR₂), determined according to ISO 1133 at 230 °C and 2.16 kg, in the range from 3.0 to 30.0 g/10 min, more preferably in the range from 4.0 to 20.0 g/10 min, most preferably in the range from 4.5 to 10.0 g/10 min.

The second heterophasic propylene ethylene copolymer (HECO2) preferably has a soluble fraction (SF) content, determined by crystallization extraction (CRYSTEX) analysis, in the range from 20.0 to 40.0 wt.-%, more preferably in the range from 20.0 to 30.0 wt.-%, most preferably in the range from 20.0 to 26.0 wt.-%.

The second heterophasic propylene ethylene copolymer (HECO2) preferably has an ethylene content of the soluble fraction (C2(SF)), according to crystallization extraction (CRYSTEX) analysis, determined by FT-IR spectroscopy calibrated by quantitative ¹³C-NMR spectroscopy, in the range from 18.0 to 30.0 wt.-%, more preferably in the range from 19.0 to 28.0 wt.-%, most preferably in the range from 20.0 to 26.0 wt.-%.

The second heterophasic propylene ethylene copolymer (HECO2) has an intrinsic viscosity, determined according to DIN ISO 1628/1, of the soluble fraction (iV(SF)), according to crystallization extraction (CRYSTEX) analysis, in the range from 4.10 to 10.00 dL/g, more preferably in the range from 4.50 to 8.00 dL/g, most preferably in the range from 5.00 to 6.00 dL/g.

### Third Heterophasic Propylene-Ethylene Copolymer (HECO3)

The third heterophasic propylene ethylene copolymer (HECO3) is preferably provided in an amount in the range from 0 to 35.0 wt.-%, more preferably in an amount of 0 wt.-%, relative to the total weight of the polypropylene composition (PC).

The third heterophasic propylene ethylene copolymer (HECO3) has a melt flow rate (MFR₂), determined according to ISO 1133 at 230 °C and 2.16 kg, in the range from 5.0 to 30.0 g/10 min, more preferably in the range from 10.0 to 25.0 g/10 min, most preferably in the range from 12.0 to 20.0 g/10 min.

The third heterophasic propylene ethylene copolymer (HECO3) preferably has a soluble fraction (SF) content, determined by crystallization extraction (CRYSTEX) analysis, in the range from 20.0 to 40.0 wt.-%, more preferably in the range from 24.0 to 36.0 wt.-%, most preferably in the range from 27.0 to 33.0 wt.-%.

The third heterophasic propylene ethylene copolymer (HECO3) preferably has an ethylene content of the soluble fraction (C2(SF)), according to crystallization extraction (CRYSTEX) analysis, determined by FT-IR spectroscopy calibrated by quantitative ¹³C-NMR spectroscopy, in the range from 31.0 to 45.0 wt.-%, more preferably in the range from 34.0 to 44.0 wt.-%, most preferably in the range from 37.0 to 43.0 wt.-%.

The third heterophasic propylene ethylene copolymer (HECO3) has an intrinsic viscosity, determined according to DIN ISO 1628/1, of the soluble fraction (iV(SF)), according to crystallization extraction (CRYSTEX) analysis, in the range from 2.00 to 4.00 dL/g, more preferably in the range from 2.10 to 3.50 dL/g, most preferably in the range from 2.20 to 3.00 dL/g.

### Mixed-Plastic Polypropylene Blend (B)

The mixed-plastic polypropylene blend (B) is preferably provided in an amount in the range from 7.5 to 85.0 wt.-%, more preferably in the range from 9.0 to 82.5 wt.-%, relative to the total weight of the polypropylene composition (PC).

The mixed-plastic polypropylene blend (B) is a polypropylene rich recycled material, meaning that it comprises significantly more polypropylene than polyethylene. Recycled waste streams, which are high in polypropylene can be obtained for example from the automobile industry, particularly as some automobile parts such as bumpers are sources of fairly pure polypropylene material in a recycling stream.

Preferably, the mixed-plastic polypropylene blend (B) originates from post-consumer waste from very special sources, preferably from end-of life vehicle (ELV) recycled feedstock, more preferably from shredded bumpers.

It is especially preferred that the mixed-plastic polypropylene blend (B) in its last product cycle does not originate from post-consumer household waste.

The mixed mixed-plastic polypropylene blend (B) originates from post-consumer waste from very special sources, preferably from end-of life vehicle (ELV) recycled feedstock, more preferably from shredded bumpers, which comprises up to 50 wt.-% of a mixed-plastic polypropylene blend which in an earlier product cycle originated from post-consumer household waste. In said embodiment the polypropylene composition used for the production of the industrial purpose, such as e.g. bumpers for automotive vehicles, are mixed-plastics polypropylene blends as described e.g. in PCT/EP2022/084506.

During recycling, any reasonable measure will usually be taken for any components other than polyethylene and polypropylene to be reduced/removed as far as the final application or use suggests such measures; however, other components are often present in small amounts.

Such components include e.g. inorganic filler, which can be present in the mixed-plastic polypropylene blend (B) in an amount of from 2.5 to 30 wt.-%, preferably 3.5 to 25 wt.-%, relative to the total weight of the mixed-plastic polypropylene blend (B).

The mixed-plastic polypropylene blend (B) is characterized by the presence of inclusions attributed to automotive paints. Said inclusions are determined in the example section on compressed films with a thickness of 35 to 70 μm, wherein the inclusions are identified by optical microscopy, the chemical composition of the inclusions is characterized by infrared spectroscopy and the physical information of the inclusions is characterized by computed tomography

The inclusions attributed to automotive paints are typically particles, which comprise styrene-based components, urethane-based components and/or acrylic-based components and usually originate from paint residuals from the mixed-plastic polypropylene blend (B) such as e.g. from the painted car parts, such as bumpers. In addition to their chemical composition these inclusions can further be characterized by their 3D shape, which usually is sharp edged and platelet-like, which can have a multilayered structure and usually show an average CT grey value above a threshold of at least 50% higher compared to the average grey value of the surrounding polypropylene composition.

The mixed-plastic polypropylene blend (B) preferably has a limonene content, determined by solid phase microextraction (HS-SPME-GC-MS), of less than 0.1 ppm. In some embodiments, the limonene content is even below the detection limit of the HS-SPME-GC-MS method. The low limonene content in these embodiments results from mixed-plastic polypropylene blends (B), which do not originate from post-consumer household waste or do not contain any content of mixed plastics polypropylene blends, which in an earlier life cycle originated from post-consumer household waste.

However, in some embodiments the mixed-plastic polypropylene blends (B) include recycled blends, which in an earlier life cycle originate from post-consumer household waste typically in amounts of up to 50 wt.-%, based on the total amounts of mixed plastic polypropylene blends (B). In said embodiments the mixed-plastic polypropylene blends (B) can contain a limonene content, determined by solid phase microextraction (HS-SPME-GC-MS) an amount of not more than 10.0 ppm, such as in the range of 0.1 to 10.0 ppm.

Other such components include inorganic residue content, as determined by calcination analysis according to DIN ISO 1172:1996, of 0.5 to 10.0 wt.-%.

Further components include a content of derivatives from organic acids and/or organic aldehydes, of 1 to 100 ppm.

The mixed-plastic polypropylene blend (B) preferably has a melt flow (MFR₂), determined according to ISO 1133 at 230 °C and 2.16 kg, in the range from 5.0 to 30.0 g/10 min, more preferably in the range from 6.0 to 27.5 g/10 min, most preferably in the range from 7.5 to 25.0 g/10 min.

The mixed-plastic polypropylene blend (B) preferably has an ethylene content (C2(total)), determined from crystallization extraction (CRYSTEX) by FT-IR spectroscopy calibrated by quantitative ¹³C-NMR spectroscopy, in the range from 15.0 to 30.0 wt.-%, more preferably in the range from 17.5 to 28.5 wt.-%, most preferably in the range from 15.0 to 27.5 wt.-%.

The mixed-plastic polypropylene blend (B) preferably has a soluble fraction (SF) content of the polymeric part of the mixed-plastic polypropylene blend (B), determined by crystallization extraction (CRYSTEX) analysis, in the range from 10.0 to 50.0 wt.-%, more preferably in the range from 15.0 to 45.0 wt.-%, most preferably in the range from 20.0 to 40.0 wt.-%.

The mixed-plastic polypropylene blend (B) preferably has a crystalline fraction (CF) content of the polymeric part of the mixed-plastic polypropylene blend (B), determined by crystallization extraction (CRYSTEX) analysis, in the range from 50.0 to 90.0 wt.-%, more preferably in the range from 55.0 to 85.0 wt.-%, most preferably in the range from 60.0 to 80.0 wt.-%.

The mixed-plastic polypropylene blend (B) preferably has an ethylene content of the soluble fraction (C2(SF)), according to crystallization extraction (CRYSTEX) analysis, determined by FT-IR spectroscopy calibrated by quantitative ¹³C-NMR spectroscopy, in the range from 30.0 to 60.0 wt.-%, more preferably in the range from 32.5 to 57.5 wt.-%, most preferably in the range from 35.0 to 55.0 wt.-%.

The mixed-plastic polypropylene blend (B) preferably has an ethylene content of the crystalline fraction (C2(CF)), according to crystallization extraction (CRYSTEX) analysis, determined by FT-IR spectroscopy calibrated by quantitative ¹³C-NMR spectroscopy, in the range from 5.0 to 25.0 wt.-%, more preferably in the range from 6.5 to 22.5 wt.-%, most preferably in the range from 7.5 to 20.0 wt.-%.

The mixed-plastic polypropylene blend (B) preferably has an intrinsic viscosity, determined according to DIN ISO 1628/1, of the soluble fraction (iV(SF)), according to crystallization extraction (CRYSTEX) analysis, in the range from 1.10 to 2.75 dL/g, more preferably in the range from 1.25 to 2.60 dL/g, most preferably in the range from 1.40 to 2.50 dL/g.

The mixed-plastic polypropylene blend (B) preferably has an intrinsic viscosity, determined according to DIN ISO 1628/1, of the crystalline fraction (iV(CF)), according to crystallization extraction (CRYSTEX) analysis, in the range from 0.90 to 2.10 dL/g, more preferably in the range from 1.00 to 2.00 dL/g, most preferably in the range from 1.10 to 1.90 dL/g.

The mixed-plastics blend (B) preferably has a density in the range of 900 to 1050 kg/m³, determined according to ISO 1183.

Further, the mixed-plastics blend (B) preferably has a flexural modulus, determined according to ISO 178 using 80×10×4 mm³ test bars injection-moulded in line with ISO 19069-2, of from 900 to 2200 MPa, more preferably from 950 to 2000 MPa.

Still more preferably, the mixed-plastics blend (B) preferably has a Charpy Notched impact strength at 23 °C, determined according to ISO 179 using 80×10×4 mm³ test bars injection-moulded in line with ISO 19069-2, in the range from 10.0 to 70.0 kJ/m², preferably from 15.0 to 60 kJ/m².

### Ethylene-1-Octene Elastomer (EC)

The ethylene-1-octene elastomer (EC) is an elastomeric copolymer containing ethylene monomers and 1-octene comonomers.

The ethylene-1-octene elastomer (EC) is preferably provided in an amount in the range from 0 to 7.5 wt.-%, more preferably in the range from 0 to 6.5 wt.-%, relative to the total weight of the polypropylene composition (PC).

The ethylene-1-octene elastomer (EC) preferably is a virgin polymer, which is compounded to the other components.

Residual ethylene-1-octene elastomer (EC), which may be present in the mixed-plastic polypropylene blend (B) is not subsumed under ethylene-1-octene elastomer (EC).

The ethylene-1-octene elastomer (EC) preferably has a melt flow rate (MFR₂), determined according to ISO 1133 at 190 °C and 2.16 kg, in the range from 0.2 to 2.5 g/10 min, more preferably in the range from 0.3 to 1.5 g/10 min, most preferably in the range from 0.4 to 1.0 g/10 min.

The ethylene-1-octene elastomer (EC) preferably has a density, determined according to ISO 1183-187, in the range from 850 to 870 kg/m³, more preferably in the range from 855 to 867 kg/m³, most preferably in the range from 860 to 865 kg/m³.

### Inorganic Filler (F)

The inorganic filler (F) is preferably provided in an amount in the range from 0 to 25.0 wt.-%, more preferably in the range from 0 to 21.0 wt.-%, most preferably in the range from 12.0 to 18.0 wt.-%, relative to the total weight of the polypropylene composition (PC).

The inorganic filler (F) preferably is a virgin filler, which is compounded to the other components.

Residual inorganic filler, which may be present in the mixed-plastic polypropylene blend (B) is not subsumed under inorganic filler (F).

It is preferred that the inorganic filler is selected from the group containing talc, calcium carbonate, barium sulfate, mica, and mixtures thereof.

Most preferably, the inorganic filler (F) is talc.

It is preferred that the inorganic filler (F) has a median diameter (d₅₀) in the range from 1.0 to 15.0 μm, more preferably in the range from 2.0 to 10.0 μm, most preferably in the range from 2.5 to 5.0 μm.

It is preferred that the inorganic filler (F) has a top cut diameter (d₉₅) in the range from 2.0 to 30.0 μm, more preferably in the range from 4.0 to 20.0 μm, most preferably in the range from 5.0 to 10.0 μm.

### Pigment Masterbatch (P)

The polypropylene composition (PC) is preferably a pigmented polypropylene composition.

As such, a pigment masterbatch (P) is preferably provided in an amount in the range from 0.5 to 10.0 wt.-%, more preferably in the range from 2.0 to 10.0 wt.-%, relative to the total weight of the polypropylene composition (PC).

The pigment masterbatch has a total pigment content in the range from 40.0 to 80.0 wt.-%, relative to the total weight of the pigment masterbatch (P). The pigment masterbatch (P) may comprise one pigment, or it may comprise multiple pigments. When the pigment masterbatch (P) comprises more than one pigment, the pigment masterbatch may be provided as multiple pigment masterbatches, each containing a single pigment, wherein the sum of the amounts of the individual pigment masterbatches equals the total weight of the pigment masterbatch (P) according to the present invention.

The selection of the pigment depends on the intended colour of the polypropylene composition (PC). Beyond such considerations, the choice of suitable pigment is not restricted. The person skilled in the art would be able to select suitable pigment(s) to achieve a certain end colour of the composition.

### Additives (A)

The further additives (A) are preferably provided in an amount in the range from 0.2 to 5.0 wt.-%. The skilled practitioner would be able to select suitable additives that are well known in the art.

The additives (A) are preferably selected from antioxidants, UV-stabilisers, anti-scratch agents, mold release agents, acid scavengers, lubricants, anti-static agents, and mixtures thereof.

It is understood that the content of additives (A), given with respect to the total weight of the polypropylene composition (PC), includes any carrier polymers used to introduce the additives to said polypropylene composition (PC), i.e. masterbatch carrier polymers. An example of such a carrier polymer would be a polypropylene homopolymer in the form of powder.

### Article

In another aspect, the present invention is directed to an article, preferably an injection-moulded article, comprising the polypropylene composition according to any one of the preceding claims in an amount of at least 95 wt.-%, more preferably at least 98 wt.-%, most preferably at least 99 wt.-%.

Preferably the article, more preferably the injection-moulded article, is an automotive interior article, more preferably selected from the group consisting of dashboards, step assists, interior trims, ash trays, interior body panels and gear shift levers.

The article comprising, preferably consisting of the polypropylene composition (PC) has been found to show a good balance of properties in regard of surface quality and toughness after processing.

The article preferably has a scratch resistance at 10 N in the range from −0.20 to 1.00, more preferably in the range from 0.00 to 0.75.

Further, the article preferably has an average coefficient of linear thermal expansion at a temperature range from +23 to +80 °C at a heating rate of 1 °C/min in machine direction (average CLTE 23-80 °C) of below 150 μm/m °C, such as not more than 140 μm/m °C, more preferably not more than 135 μm/m °C, still more preferably not more than 115 μm/m° °C, most preferably not more than 112 μm/m °C. The lower limit of the average CLTE 23-80 °C is usually at least 70 μm/m °C, preferably at least 75 μm/m °C.

The average CLTE 23-80 °C can be the arithmetic mean of CLTE 23-80 °C, MD and CLTE 23-80 °C, TD.

Additionally, the article preferably has an average coefficient of linear thermal expansion at a temperature range from −30 to +80 °C at a heating rate of 1 °C/min in machine direction (average CLTE-30-80 °C) of below 120 μm/m °C, such as not more than 115 μm/m °C, more preferably not more than 95 μm/m °C, still more preferably not more than 91 μm/m °C, most preferably not more than 90 μm/m °C. The lower limit of the average CLTE-30-80 °C is usually at least 55 μm/m °C, preferably at least 60 μm/m °C.

The average CLTE −30-80 °C can be the arithmetic mean of CLTE −30-80 °C, MD and CLTE −30-80 °C, TD.

The coefficient of linear thermal expansion is usually measured on 10 mm long pieces cut from the center of injection moulded bar test specimens of 80×10×4 mm³ prepared in accordance with ISO 19069-2.

The average CLTE 23-80 °C and the average CLTE −30-80 °C can also be determined from test specimens of the accordant dimensions cut out of injection moulded articles, like injection moulded automotive articles, from the arithmetic mean of the coefficient of linear thermal expansion coefficients measured on said test specimens in two orthogonal directions.

Further, the article preferably has an isotropic area shrinkage of not more than 1.50%, more preferably not more than 1.40%, still more preferably not more than 1.15%, most preferably not more than 1.10%, determined on injection moulded samples.

The lower limit of the isotropic area shrinkage, determined on injection moulded samples, is usually at least 0.25%, preferably 0.50%.

### Examples

### 1. Measuring Methods

The following definitions of terms and determination methods apply for the above general description of the invention including the claims as well as to the below examples unless otherwise defined.

### Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Avance III 500 NMR spectrometer operating at 500.13 and 125.76 MHz for 1H and ¹³C respectively. All spectra were recorded using a ¹³C optimised 7 mm magic-angle spinning (MAS) probehead at 180 °C using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification {klimke06, parkinson07, castignolles09}. Standard single-pulse excitation was employed utilising the NOE at short recycle delays of 3 s {pollard04, klimke06} and the RS-HEPT decoupling scheme {fillip05, griffin07}. A total of 1024 (1 k) transients were acquired per spectra.

Quantitative ¹³C{¹H} NMR spectra were processed, integrated and relevant quantitative properties determined from the integrals. All chemical shifts are internally referenced to the methyl isotactic pentad (mmmm) at 21.85 ppm. Characteristic signals corresponding to the incorporation of 1-butene were observed {brandolini01} and the comonomer content quantified.

The amount of isolated 1-butene incorporated in PBP sequences was quantified using the integral of the αB2 sites at 43.6 ppm accounting for the number of reporting sites per comonomer:

B=I_{αB2}/2

The amount of consecutively incorporated 1-butene in PBBP sequences was quantified using the integral of the ααB2B2 site at 40.5 ppm accounting for the number of reporting sites per comonomer:

BB=2*I_{ααB2B2}

In presence of BB the value of B must be corrected for the influence of the αB2 sites resulting from BB:

B=(I_{αB2}/2)−BB/2

The total 1-butene content was calculated based on the sum of isolated and consecutively incorporated 1-butene:

Bₜₒₜₐₗ=B+BB

Characteristic signals corresponding to the incorporation of ethylene were observed {brandolini01} and the comonomer content quantified.

The amount of isolated ethylene incorporated in PEP sequences was quantified using the integral of the Sββ sites at 24.3 ppm accounting for the number of reporting sites per comonomer:

E=I_{Sββ}

If characteristic signals corresponding to consecutive incorporation of ethylene in PEE sequence was observed the Sβδ site at 27.0 ppm was used for quantification:

EE=I_{Sβδ}

Characteristic signals corresponding to regio defects were observed {resconi00}. The presence of isolated 2,1-erythro regio defects was indicated by the presence of the two methyl sites at 17.7 and 17.2 ppm, by the methylene site at 42.4 ppm and confirmed by other characteristic sites. The presence of 2,1 regio defect adjacent an ethylene unit was indicated by the two inequivalent Sαβ signals at 34.8 ppm and 34.4 ppm respectively and the Tγγ at 33.7 ppm.

The amount of isolated 2, 1-erythro regio defects (P_{21e isolated}) was quantified using the integral of the methylene site at 42.4 ppm (Iₑ₉):

P_{21e isolated}=Iₑ₉

If present the amount of 2,1 regio defect adjacent to ethylene (P_{E21}) was quantified using the methine site at 33.7 ppm (I_{Tγγ}):

P_{E21}=I_{Tγγ}

The total ethylene content was then calculated based on the sum of ethylene from isolated, consecutively incorporated and adjacent to 2,1 regio defects:

Eₜₒₜₐₗ=E+EE+P_{E21}

The amount of propylene was quantified based on the Sαα methylene sites at 46.7 ppm including all additional propylene units not covered by Sαα e.g. the factor 3*P_{21e isolated} accounts for the three missing propylene units from isolated 2,1-erythro regio defects:

Pₜₒₜₐₗ=I_{Sαα}+3*P_{21e isolated}+B+0.5*BB+E+0.5*EE+2*P_{E21}

The total mole fraction of 1-butene and ethylene in the polymer was then calculated as:

fB=Bₜₒₜₐₗ/(Eₜₒₜₐₗ+Pₜₒₜₐₗ+Bₜₒₜₐₗ)

fE=Eₜₒₜₐₗ/(Eₜₒₜₐₗ+Pₜₒₜₐₗ+Bₜₒₜₐₗ)

The mole percent comonomer incorporation was calculated from the mole fractions:

B[mol %]=100*fB

E[mol %]=100*fE

The weight percent comonomer incorporation was calculated from the mole fractions:

B[wt.-%]=100*(fB*56.11)/((fE*28.05)+(fB*56.11)+((1−(fE+fB))*42.08))

E[wt.-%]=100*(fE*28.05)/((fE*28.05)+(fB*56.11)+((1−(fE+fB))*42.08))

The mole percent of isolated 2,1-erythro regio defects was quantified with respect to all propylene:

[21e]mol %=100*P_{21e isolated}/Pₜₒₜₐₗ

The mole percent of 2,1 regio defects adjacent to ethylene was quantified with respect to all propylene:

[E21]mol %=100*P_{E21}/Pₜₒₜₐₗ

The total amount of 2,1 defects was quantified as following:

[21]mol %=[21e]+[E21]

Characteristic signals corresponding to other types of regio defects (2, 1-threo, 3,1 insertion) were not observed {resconi00}.

Literature (as referred to above):

| | |
|---|---|
| klimke06 | Klimke, K., Parkinson, M., Piel, C., Kaminsky, W., |
| | Spiess, H. W., Wilhelm, M., Macromol. |
| | Chem. Phys. 2006; 207: 382. |
| parkinson07 | Parkinson, M., Klimke, K., Spiess, H. W., |
| | Wilhelm, M., Macromol. Chem. Phys. 2007; 208: 2128. |
| pollard04 | Pollard, M., Klimke, K., Graf, R., Spiess, H. W., |
| | Wilhelm, M., Sperber, O., Piel, C., Kaminsky, W., |
| | Macromolecules 2004; 37: 813. |
| filip05 | Filip, X., Tripon, C., Filip, C., J. Mag. Resn. |
| | 2005, 176, 239 |
| griffin07 | Griffin, J. M., Tripon, C., Samoson, A., Filip, C., |
| | and Brown, S. P., Mag. Res. in Chem. 2007 45, |
| | S1, S198. |
| castignolles09 | Castignolles, P., Graf, R., Parkinson, M., Wilhelm, M., |
| | Gaborieau, M., Polymer 50 (2009) 2373. |
| resconi00 | Resconi, L., Cavallo, L., Fait, A., Piemontesi, F., |
| | Chem. Rev. 2000, 100, 1253. |
| brandolini01 | A.J. Brandolini, D. D. Hills, “NMR spectra of |
| | polymers and polymer additives”, Marcel Deker |
| | Inc., 2000 |

### Crystallization Extraction (CRYSTEX) Analysis

Note: Crystallization extraction (CRYSTEX) analysis analyses the polymeric part of each component, with non-polymeric parts, such as any fillers or particulate pigments, not contributing to the reported CRYSTEX data presented.

Determination of Crystalline and Soluble Fractions and their Respective Properties (iV and Ethylene Content)

The crystalline (CF) and soluble fractions (SF) of the polypropylene compositions as well as the comonomer content and intrinsic viscosities of the respective fractions were analyzed by use of the Crystex (crystallisation extraction) method. Potential instruments that can be used are Crystex QC or Crystex 42 (Polymer Char; Valencia, Spain). Details of the technique and the method can be found in literature (Ljiljana Jeremic, Andreas Albrecht, Martina Sandholzer & Markus Gahleitner (2020): Rapid characterization of high-impact ethylene-propylene copolymer composition by crystallization extraction separation: comparability to standard separation methods, International Journal of Polymer Analysis and Characterization, 25:8, 581-596).

The crystalline and amorphous fractions are separated through temperature cycles of dissolution at 160 °C, crystallization at 40 °C and re-dissolution in 1,2,4-trichlorobenzene at 160 °C. Quantification of SF and CF and determination of ethylene content (C2) are achieved by means of an integrated infrared detector (IR4) and for the determination of the intrinsic viscosity (IV) an online 2-capillary viscometer is used.

The IR4 detector is a multiple wavelength detector measuring IR absorbance at two different bands (CH3 stretching vibration (centred at app. 2960 cm⁻¹) and the CH stretching vibration (2700-3000 cm⁻¹) that are serving for the determination of the concentration and the Ethylene content in Ethylene-Propylene copolymers. The IR4 detector is calibrated with series of 8 EP copolymers with known Ethylene content in the range of 2 wt.-% to 69 wt.-% (determined by 13C-NMR) and each at various concentrations, in the range of 2 and 13 mg/ml. To encounter for both features, concentration and ethylene content at the same time for various polymer concentrations expected during Crystex analyses the following calibration equations were applied:

Conc=a+b*Abs(CH)+c*(Abs(CH))²+d*Abs(CH₃)+e*(Abs(CH₃)²+f*Abs(CH)*Abs(CH₃) (Equation 1)

CH₃/1000C=a+b*Abs(CH)+c*Abs(CH₃)+d*(Abs(CH₃)/Abs(CH))+e*(Abs(CH₃)/Abs(CH))² (Equation 2)

The constants a to e for equation 1 and a to f for equation 2 were determined by using least square regression analysis.

The CH₃/1000C is converted to the ethylene content in wt.-% using following relationship:

Wt.-%(Ethylene in EP Copolymers)=100−CH₃/1000TC*0.3 (Equation 3)

Amounts of Soluble Fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO16152. XS calibration is achieved by testing various EP copolymers with XS content in the range 2-31 wt.-%. The determined XS calibration is linear:

Wt.-% XS=1,01*Wt.-% SF (Equation 4)

Intrinsic viscosity (IV) of the parent EP copolymer and its soluble and crystalline fractions are determined with a use of an online 2-capillary viscometer and are correlated to corresponding IV's determined by standard method in decalin according to ISO 1628-3. Calibration is achieved with various EP PP copolymers with IV=2-4 dL/g. The determined calibration curve is linear:

IV(dL/g)=a*Vsp/c (equation 5)

The samples to be analyzed are weighed out in concentrations of 10 mg/ml to 20 mg/ml. To avoid injecting possible gels and/or polymers which do not dissolve in TCB at 160 °C, like PET and PA, the weighed out sample was packed into a stainless steel mesh MW 0,077/D 0,05 mmm.

After automated filling of the vial with 1,2,4-TCB containing 250 mg/l 2,6-tert-butyl-4-methylphenol (BHT) as antioxidant, the sample is dissolved at 160 °C until complete dissolution is achieved, usually for 60 min, with constant stirring of 400 rpm. To avoid sample degradation, the polymer solution is blanketed with the N2 atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the IV[dl/g] and the C2[wt. %] of the PP composition. During the second injection the soluble fraction (at low temperature) and the crystalline fraction (at high temperature) with the crystallization cycle are measured (wt.-% SF, wt.-% C2, IV).

### Intrinsic Viscosity

The intrinsic viscosity (IV) is measured according to DIN ISO 1628/1, October 1999, in Decalin at 135 °C.

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR₂ of polypropylene is determined at a temperature of 230 °C and a load of 2.16 kg.

The MFR₂ of polyethylene is determined at a temperature of 190 °C and a load of 2.16 kg.

### Density:

The density is measured according to ISO 1183-187. Sample preparation is done by compression moulding in accordance with ISO 1872-2:2007.

The xylene soluble fraction at room temperature (XCS, wt.-%): The amount of the polymer soluble in xylene is determined at 25 °C according to ISO 16152; 5th edition; 2005 Jul. 1.

DSC analysis, melting temperature (Tₘ) and heat of fusion (H_{f}), crystallization temperature (T_{c}) and heat of crystallization (H_{c}): measured with a TA Instrument Q200 differential scanning calorimetry (DSC) on 5 to 7 mg samples. DSC is run according to ISO 11357/part 3/method C2 in a heat/cool/heat cycle with a scan rate of 10 °C/min in the temperature range of −30 to +225 °C. Crystallization temperature (T_{c}) and crystallization enthalpy (H_{c}) are determined from the cooling step, while melting temperature (Tₘ) and melting enthalpy (Hₘ) are determined from the second heating step.

The Flexural Modulus is determined according to ISO 178 method A (3-point bending test) on 80 mm×10 mm×4 mm specimens. Following the standard, a test speed of 2 mm/min and a span length of 16 times the thickness was used. The testing temperature was 23±2 °C. Injection moulding was carried out according to ISO 19069-2 using a melt temperature of 230 °C for all materials irrespective of material melt flow rate.

### Notched Impact Strength (NIS)

The Charpy notched impact strength (NIS) was measured according to ISO 179 1 eA at +23 °C or −20 °C, using injection moulded bar test specimens of 80×10×4 mm³ prepared in accordance with ISO 19069-2 using a melt temperature of 230 °C for all materials irrespective of material melt flow rate.

### Instrumented Puncture Test

Instrumented puncture test was performed on 60×60×3 mm³ injection-molded plaques, prepared in accordance with ISO 19069-2, at −30 °C according to ISO 6603-2:2000. The measurement was done after 96 h conditioning time of the specimen at +23 °C, the test was conducted at −30 °C. Test specimens of the accordant dimensions can also be cut from samples of injection moulded articles, such as injection moulded automotive articles.

Average Particle Size (Diameter) d₅₀ and Top Cut d₉₅

The particle size defintions were calculated from the particle size distribution [mass percent] as determined by laser diffraction method, using Laser Mastersizer, according to ISO 13320-1. The d₅₀ is defined as the median diameter, whilst d₉₅ is the diameter at the 95th percentile, as observed from the particle size distribution.

### Scratch Resistance

To determine the scratch visibility, a Cross Hatch Cutter Model 420P, manufactured by Erichsen, was used. For the tests, plaques of 70×70×4 mm size were cut from a moulded grained plaque of size 140×200×4 mm (grain parameters: average grain size=1 mm, grain depth=0.12 mm, conicity=) 6°. The period between injection moulding of specimens and scratch-testing was 7 days. For testing, the specimens must be clamped in a suitable apparatus as described above. Scratches were applied at a force of 10 N using a cylindrical metal pen with a ball shaped end (radius=0.5 mm±0.01). A cutting speed of 1000 mm/min was used. A minimum of 20 scratches parallel to each other were brought up at a load of 10 N with a distance of 2 mm. The application of the scratches was repeated perpendicular to each other, so that the result was a scratching screen. The scratching direction should be unidirectional.

The scratch visibility is reported as the difference of the luminance, ΔL, of the unscratched and the scratched areas. ΔL values were measured using a spectrophotometer that fulfils the requirements to DIN 5033. A detailed test description of the test method (Erichsen cross hatch cutter method) can be found in the article “Evaluation of scratch resistance in multiphase PP blends” by Thomas Koch and Doris Machl, published in Polymer Testing, 26 (2007), p. 927-936.

### Inorganic Residues

Inorganic residues are quantified according to DIN ISO 1172:1996 using a Perkin Elmer TGA 8000. Approximately 10-20 mg of material was placed in a platinum pan. The temperature was equilibrated at 50 °C for 10 minutes, and afterwards raised to 950 °C under nitrogen at a heating rate of 20 °C/min. The ash content was evaluated as the weight % at 850 °C.

### Limonene Detection

Limonene quantification can be carried out using solid phase microextraction (HS-SPME-GC-MS) by standard addition.

50 mg ground samples are weighed into 20 mL headspace vials and after the addition of limonene in different concentrations and a glass-coated magnetic stir bar, the vial is closed with a magnetic cap lined with silicone/PTFE. Micro capillaries (10 pL) are used to add diluted limonene standards of known concentrations to the sample. Addition of 0, 2, 20 and 100 ng equals 0 mg/kg, 0.1 mg/kg, 1 mg/kg and 5 mg/kg limonene, in addition standard amounts of 6.6 mg/kg, 11 mg/kg and 16.5 mg/kg limonene is used in combination with some of the samples tested in this application. For quantification, ion-93 acquired in SIM mode is used. Enrichment of the volatile fraction is carried out by headspace solid phase microextraction with a 2 cm stable flex 50/30 pm DVB/Carboxen/PDMS fibre at 60 °C for 20 minutes. Desorption is carried out directly in the heated injection port of a GCMS system at 270 °C.

### Gcms Parameters:

Column: 30 m HP 5 MS 0.25*0.25
Injector: Splitless with 0.75 mm SPME Liner, 270 °C.
Temperature program: −10 °C (1 min)
Carrier gas: Helium 5.0, 31 cm/s linear velocity, constant flow
MS: Single quadrupole, direct interface, 280 °C interface temperature
Acquisition: SIM scan mode
Scan parameter: 20-300 amu
SIM Parameter: m/Z 93, 100 ms dwell time

### Inclusions Attributed to Automotive Paints

The following test method description is summarizing sample preparation by compression molding of films, identification of relevant inclusions (“inclusions of interest”), IR spectroscopy for chemical identification and computed tomography (CT) for physical characterization. The purpose of this test method is to identify the presence of paint particles in PP compounds based on end-of-life vehicle PP raw materials.

### 1. Sample Preparation

Around 1-2 grams of polymer compound material taken from real parts or pellets are compressed into films of around 35-70 μm thickness by compression molding providing good visibility of inclusions and enough IR transmittance. The diameter of each compression molded film is around 8 cm. Compression molding is performed at 190 °C at around 80 bar pressure.

At least 5 inclusions that are clearly visible under the optical microscope (OM) are identified and individually marked for detailed characterization by IR and CT. Inclusions of interest are chosen by OM such that the size is preferably >100 μm, that the shape is showing sharp edges and that the color is different from that of the surrounding polymer matrix.

### 2. Method Description—Infrared Microscopy (IR)

On the compression molded films, IR microscopic measurements are carried out to identify the chemistry of the inclusions. Two sets of inclusions, viz., “inclusions of interest” and “comparative inclusions” are defined for chemical characterization by IR microscope.

IR microscopic measurements are carried out in Bruker Vertex 70 Spectrometer equipped with Hyperion 200 microscope. Infrared or FT-IR microscopy combines FT-IR spectroscopy with traditional light microscopy. This provides an easy, “point and shoot” approach to chemical analysis of very small structures. Typically, a sample/film is first visually examined and from there, a region of interest on the film is selected, which in the present case are inclusions for chemical analysis or identification. FTIR spectra are obtained using IR microscope with spectral window between 600 cm⁻¹ to 4000 cm⁻¹ and spectral resolution of 2 cm⁻¹. Spectra are processed with zero filling factor of 32 and Norton Beer strong apodization.

The “inclusions of interests” result in IR spectra with certain specific characteristics. In the FTIR spectra of inclusions of interest, sharp bands at around 700 cm⁻¹ and 760 cm⁻¹ are observed. This indicates the presence of styrene modifications (700 cm⁻¹: aromatic ring deformation of styrene, 760 cm-1: Out-of-plane deformation of the CH of Styrene) [1]. Additionally a broad hump is observed for all inclusions of interest at around 3380 cm⁻¹, which might indicate OH and NH stretching band of acrylate or urethane [2]. Further an extremely strong band at around 1700 cm⁻¹ is observed, which can also indicate the C═O stretching of urethane or acrylic linkages [3,4]. The presence of all these characteristic IR bands are in general found in paints [5]. The IR microscope spectra of “comparative inclusions” does not show the presence of these unique combination of bands. Hence, it can be clearly concluded that the “comparative inclusions” are chemically different from the “inclusions of interest” and that “inclusions of interest” show characteristic IR bands which are indicative for paints used in automotive applications.

### 3. Method Description—Computed Tomography (CT)

CT is carried out to determine the physical information of the marked inclusions. For each inclusion, 3D shape, grey value distribution and average grey value are determined. The source of grey value contrast between paint residues and PP is the color pigments having higher density.

X-ray Computed Tomography (CT) is performed using a Thermo Fisher Scientific Heliscan MK2 (Thermo Fisher Scientific) device. Around the inclusions, ca. 1 cm wide parts are cut out of the compression molded films. These are stacked on top of each other and scanned all together. The Voxelsize is set to 4.5 μm. The X-ray tube is operated with LaB6 filament, voltage is set to 60 kV, focal spot size is set to medium and a pre-filter made of steel with 0.1 mm thickness is used. The specimens are scanned with Space Filling trajectory.

Together with the specimens, discs with 5 mm in diameter and 500 μm in thickness, made of different polymers, glass and aluminum, are scanned at once. These discs act as reference for the determination of relevant grey value regimes since grey values correlate with density.

The software Avizo for industrial inspection (Thermo Fisher Scientific) is used for data analysis.

The grey value distribution of a inclusion can be inhomogeneous showing pigments with different sizes.

### 4. Definition of Criteria for Paint Residue Identification (“Inclusions of Interest”)

The appearance under the optical microscope is sharp edged and of different color compared to the polymer matrix background.
The IR spectrum contains the features indicating the presence of styrene modifications, acrylates or urethanes in the way as described above.
The CT determined 3D shape of paint residues is sharp edged and platelet-like. Single inclusions can consist of more than one platelet resulting in a multilayered structure.
Paint residues have average CT grey values that are at least 50% higher compared to the average PP grey value.

Inclusions that are more round shaped or have smooth edges or show grey values below the defined grey value or do not show the characteristic features in the IR spectrum are considered as “comparative inclusion”.

### 5. References

1. J. Zie ba-Palus, J. M. Milczarek and P. Ko′scielniak, Anal. Chem., 2008, 53, 109-121.
2. J. L. Dupuie, W. H. Weber, D. J. Scholl and J. L. Gerlock, Polym. Degrad. Stab., 1997, 57, 339-348.
3. T. Nguyen, J. W. Martin, E. Byrd and E. Embree, Proc. Ann. Meet. Program FSC, 2002, p. 1.
4. K. J. Van der Pal, G. Sauzier, M. Maric, W. Van Bronswijk, K. Pitts and S. W. Lewis, Talanta, 2016, 148, 715-720.
5. A. G. Gomes de Oliveira, E. W. J. de Andrade Gomes, K. Malek, Anal. Methods, 2018, 10, 1203

### Static Headspace Analysis for Determination of Odorant Contents

The parameters of the applied headspace gas chromatography mass spectrometry (HS/GC/MS) method are described here.

For the measurement of a standard solution, 5 μl of a standard solution containing 0.072 μg/ml acetaldehyde, 0.208 μg/ml acetic acid, 0.081 μg/ml D-limonene and 1.499 μg/ml acetone in 2-butanol solvent were injected into a 20 ml HS vial and tightly closed with a PTFE cap. Each HS/GC/MS test sequence of sample measurements included the analysis of such a standard.

The samples were also analysed by HS/GC/MS in order to determine acetaldehyde, acetic acid, D-limonene and acetone. Therefore, aliquots of 2.000±0.100 g of a cryo-milled sample were weighed in a 20 ml HS vial and tightly sealed with a PTFE cap. The sample was cut from the middle of an injection-moulded plate with a dimensions of 148.5×210×3 mm. The plate was produced on an injection-moulding machine Engel ES 1050/250 HL having melting temperature of 240 °C, using holding pressure of 419 bar at 3.5 s. After production, the plates were stored at ambient conditions for 24 h and subsequently packed in AI-bags.

The samples were analysed by HS/GC/MS at 100 °C/2 h isothermal headspace conditions.

Applied headspace parameters for the analyses of standards and samples differed in the vial equilibration time and the HS oven temperature. Apart from that, method parameters were kept the same for standard and sample runs. The mass spectrometer was operated in scan mode and a total ion chromatogram (TIC) was recorded for each analysis. Identification of substances was supported by deconvolution and a retention time comparison to the respective marker substance in the standard. More detailed information on method parameters and data evaluation software is given below:
HS parameter (Agilent G1888 Headspace Sampler)
   Vial equilibration time: 5 min (standard), 120 min (sample)
   Oven temperature: 200 °C (standard), 100 °C (sample)
   Loop temperature: 205 °C.
   Transfer line temperature: 210 °C
   Low shaking
GC parameter (Agilent 7890A GC System)
   Column: ZB-WAX 7HG-G007-22
   (30 m×250 μm×1 μm)
   Carrier gas: Helium 5.0
   Flow: 2 ml/min
   Split: 10:1
   GC oven program: 35 °C for 0.1 min
      10 °C/min until 250 °C.
      250 °C for 1 min
MS parameter (Agilent 5975C inert XL MSD)
   Acquisition mode: Scan
   Scan parameters:
      Low mass: 20
      High mass: 200
      Threshold: 10
Software/Data evaluation
   MSD ChemStation F.01.03.2357
   MSD ChemStation E.02.02.1431
   AMDIS GC/MS Analysis Version 2.71
   NIST Mass Spectral Library (Version 2011) NIST11.L
   Microsoft Excel Versions 2010 and 2016

### Data Evaluation

For further data evaluation extracted ion chromatograms (EICs) of the measured marker compounds in the standard and in the samples were used. The corresponing target ions are depicted in table 1.

TABLE 1
Retention times and substance specific target
ions of selected marker substances.

| | Retention | Target |
|---|---|---|
| Substance | time/min | ion (m/z) |
| Acetaldehyde | 1.6 | 44 |
| Acetone | 2.3 | 58 |
| D-Limonene | 7.6 | 136 |
| Acetic acid | 11.5 | 60 |

The standard concentration of a marker substance in the HS vial

$$( {C}_{G}^{Standard} [ mg / {m}^{3} ] )$$

was calculated according to equation 1, where the marker substance concentration in the liquid standard

$$( {C}_{L}^{Standard} [ μ g / ml ] )$$

was maniplied by the injection volume

$$( {V}_{L}^{Injection} [ μ l ] )$$

of the standard and divided by the volume of the HS vial

$$( {V}_{G}^{HS} [ ml ] ) .$$

Here, a HS volume of 20 ml is used by default.

$${C}_{G}^{Standard} = \frac{{c}_{L}^{Standard} * {V}_{L}^{Injection}}{{V}_{G}^{HS}} \qquad Equation 1$$

For each marker compound in the standard a response factor (Rf) was calculated according to equation 2.

$$Rf = \frac{{c}_{G}^{Standard}}{Peak {area}^{Standard}} \qquad Equation 2$$

Therein, the marker compound concentration is divided by the integrated peak area of the corresponding marker compound in the EIC (Peak area^{Standard}).

In order to estimate the respective marker compound concentration in the headspace of a sample

$$( {C}_{G}^{Sample} [ mg / {m}^{3} ] ) ,$$

equation 3 was used. Therefore, the obtained response factor from equation 2 is multiplied by the peak area of the corresponding marker compound in the EIC of the sample run (Peak area^{Sample}).

$${C}_{G}^{Sample} = Rf * Peak {area}^{Sample} \qquad Equation 3$$

### Fogging

Fogging was measured according to ISO 75201:2011-11, method B (gravimetric method) on specimens (diameter 80 mm+/−1 mm, thickness 3 mm) cut out from an injection moulded plate. The injection-moulded plates has dimensions of 148.5×210×3 mm. The plate was produced on an injection-moulding machine Engel ES 1050/250 HL having melting temperature of 240 °C, using holding pressure of 419 bar at 3.5 s. After production, the plates were stored at ambient conditions for 24 h and subsequently packed in AI-bags. With this method, the mass of fogging condensate on aluminium foil in mg by means weighing of foil before and after the fogging test is determined. The term “fogging” refers to a fraction of volatile substances condensed on glass parts as e.g. the windscreen of a vehicle.

### Screening of Organic Emissions by Thermo-Desorption Analysis (LBS and HBS)

This method describes the semi-quantitative determination of organic compounds emitting from polyolefins. It is similar to the VDA 278 (October 2011) but includes specific adjustments.

After the production the sample (injection moulded plaque, DIN-A5) is stored for 24 h at ambient temperature and sealed in an aluminium-coated polyethylene bag and provided to the lab within 14 days. After this period, an aliquot of 60±5 mg is prepared from the stored sample. Trimming the aliquot should aim for a maximum coherent area. It is not the aim to create the largest possible surface area by cutting the aliquot into smaller pieces. The diameter of the sample injection tube should be used first. Length and thickness should be chosen accordingly, considering the specified aliquot weight. The aliquot is directly desorbed using heat and a flow of helium gas. Volatile and semi-volatile organic compounds are extracted into the gas stream and cryo-focused prior to the injection into a gas chromatographic (GC) system for analysis. The method comprises two extraction stages: In the analysis of low-boiling substances (LBS) the aliquot is desorbed at 90 °C for 30 min to determine volatile organic compounds in the boiling/elution range up to n-C25 (n-pentacosane). The analysis of high-boiling substances (HBS) involves a further desorption step of the same aliquot at 120 °C for 60 min to determine semi-volatile compounds in the boiling/elution range from n-C14 (n-tetradecane) to n-C32 (n-dotriacontane).

Similar to the VOC and FOG value in the VDA 278, the LBS is calculated as toluene equivalent (TE) and the HBS is calculated as hexadecane equivalent (HE) applying a semi-quantitation and a respective calibration. The result is expressed in “μg/g”. Integration parameters for the LBS and HBS evaluation are chosen in such way that the “area reject” corresponds to the area of 1 μg/g (TE and HE, respectively). Thus, smaller peaks do not add to the semi-quantitative result. The GC oven program is kept the same, no matter if a calibration run, an LBS run or an HBS run was performed. It starts at 50 °C (1 min hold), followed by a ramp of 10 °C/min and an end temperature of 320 °C (10 min hold). For the GC column an Agilent DB5: 50 m×250 μm×0.25 μm (or comparable) is used. The method requires a Thermal Desorption System TDS 3 (Gerstel) and a Cooled Injection System CIS 4 (Gerstel) as well as a GC system with a flame ionisation detector (FID) but does not involve a mass spectrometer. Instead of 280 °C the CIS end temperature is always set to 380 °C.

### Coefficient of Linear Thermal Expansion (CLTE)

The coefficient of linear thermal expansion (CLTE) was determined in accordance with ISO 11359-2:1999 on 10 mm long pieces cut from the center of same injection molded specimens as used for the flexural modulus determination or Charpy notched impact strength determination. The dimension of CLTE specimen was 10×10×4 mm³ for CLTE MD measurement and 8×10×4 mm³ for CLTE TD measurement. Test specimens of the accordant dimensions can also be cut from samples of injection moulded articles, such as injection moulded automotive articles. The measurement was performed in a temperature range from −30 to +80 °C at a heating rate of 1 °C/min and a temperature range from 23 to +80 °C at a heating rate of 1 °C/min in machine direction, respectively.

The average CLTE is the average value of the CLTE MD measurement and the CLTE TD measurement.

### Isotropic Area Shrinkage

The area shrinkage was calculated from shrinkage data determined on circular sector plates of 320 mm radius, 20° opening angle and 2.8 mm thickness produced by injection moulding with an Engel ES 1350/350 machine and filled through a rectangular gate of 7.6×2.8 mm² at the base of the sector. Test specimens of the accordant dimensions can also be cut from samples of injection moulded articles, such as injection moulded automotive articles. A melt temperature of 240 °C, a mould temperature of 25 °C and a filling time of 3.5 s were used, followed by a holding time of 20 s at a holding pressure of 400 bar.

Instead of measuring the external dimension of the plates, a pattern of circular dots was generated on the plates by eroded spots of 1 mm diameter at distances between 5 and 10 mm. The original pattern is recorded immediately after de-moulding by an OGP Smartscope Flash 400 optical gauging system and used as dimensional reference. After 96 h at 23 °C, the post-shrinkage moulding pattern is determined and all deviations of point-to-point distances are recorded. For calculating the isotropic area shrinkage, a number of measuring points is connected by vectors and the resulting area determined, with A being the area after 96 h and A₀ the area before that period. The isotropic area shrinkage, Sᵢₛₒ, is then calculated as

$${S}_{iso} = 1 - \sqrt{\frac{\sum A}{\sum {A}_{0}}}$$

### 2. Examples

### Synthesis of Heterophasic Propylene-Ethylene Copolymers (HECOs)

The catalyst used for producing HECO1 was a Ziegler-Natta catalyst commercially available from Lyondell Basell (IT), under the trade name ZN180M.

The catalyst used for producing HECO2 was a Ziegler-Natta catalyst from Borealis having Ti-content of 1.9 wt.-% (as described in EP 591 224). Before the polymerization, the catalyst was prepolymerized with vinyl-cyclohexane (VCH) as described in EP 1 028 984 and EP 1 183 307. The ratio of VCH to catalyst of 1:1 was used in the preparation, thus the final poly-VCH content was less than 100 ppm.

In the first stage the catalyst described above was fed into prepolymerization reactor together with propylene and small amount of hydrogen (2.5 g/h) and ethylene (330 g/h). Triethylaluminium as a cocatalyst and dicyclopentyldimethoxysilane as a donor was used. The aluminium to donor ratio was 7.5 mol/mol and aluminium to titanium ratio was 300 mol/mol. Reactor was operated at a temperature of 30 °C and a pressure of 55 barg.

The subsequent polymerization has been effected under the following conditions.

TABLE 1
Polymerization conditions for the HECOs

| | | HECO1 | HECO2 |
|---|---|---|---|
| [Co]/[ED] | [mol/mol] | 10 | 6 |
| [Co]/[Ti] | [mol/mol] | 220 | 200 |
| Temperature | [°C] | 30 | 30 |
| Residence time | [min] | 5 | 0.25 |

Loop reactor

| | | | |
|---|---|---|---|
| Temperature | [°C] | 75 | 85 |
| Split | [wt.-%] | 52 | 35 |
| H2/C3 | [kg/ton] | 22 | 65 |
| MFR₂ | [g/10 min] | 160 | 140 |

1^{st} Gas phase reactor

| | | | |
|---|---|---|---|
| Temperature | [°C] | 80 | 85 |
| Split | [wt.-%] | 34 | 40 |
| H2/C3 | [mol/kmol] | 175 | 21 |
| MFR₂ | [g/10 min] | 160 | 55 |
| XCS | [wt.-%] | 2.0 | 1.9 |

2^{nd} Gas phase reactor

| | | | |
|---|---|---|---|
| Temperature | [°C] | 80 | 85 |
| Split | [wt.-%] | 14 | 15 |
| H2/C3 | [mol/kmol] | 250 | 15 |
| C2/C3 | [mol/kmol] | 550 | 210 |
| MFR₂ | [g/10 min] | 99 | 20 |
| C2 | [wt.-%] | 6.5 | 4.5 |

3^{rd} Gas phase reactor

| | | | |
|---|---|---|---|
| Temperature | [°C] | — | 85 |
| Split | [wt.-%] | — | 10 |
| H2/C3 | [mol/kmol] | — | 10 |
| C2/C3 | [mol/kmol] | — | 210 |
| MFR₂ | [g/10 min] | — | 5.5 |
| C2 | [wt.-%] | — | 7 |

Final Properties (pellet)

| | | | |
|---|---|---|---|
| MFR₂ | [g/10 min] | 100 | 5.5 |
| C2 | [wt.-%] | 6.5 | 7.0 |
| SF | [wt.-%] | 15 | 23 |
| C2(SF) | [wt.-%] | 29 | 23 |
| iV(SF) | [dL/g] | 2.9 | 5.3 |
| Tₘ | [°C] | 165 | 166 |
| T_{c} | [°C] | 121 | 115 |

The heterophasic copolymers HECO1 and HECO2 were compounded in a co-rotating twin-screw extruder Coperion ZSK 47 at 220 °C with 0.15 wt.-% antioxidant (Irganox B215FF from BASF AG, Germany; this is a 1:2-mixture of Pentaerythrityl-tetrakis(3-(3′,5′-di-tert. butyl-4-hydroxyphenyl)-propionate, CAS-no. 6683-19-8, and Tris(2,4-di-t-butylphenyl) phosphite, CAS-no. 31570-04-4); 0.05 wt.-% of of Ca-stearate (CAS-no. 1592-23-0, commercially available from Faci, Italy).

### Mixed-Plastic Polypropylene Blend (B)

The properties of the mixed-plastic polypropylene blends are given in Table 2. B-ELV1 and B-ELV2 are mixed-plastic polypropylene blends originating from end-of-life vehicles whereas B-PCR3 is a mixed-plastic polypropylene blend originating from post consumer waste.

For B-ELV1 and B-ELV2 shredded flakes from bumper parts from end of life vehicles were received and pelletized on a double-screw extruder using 200 μm melt filter and adding 0.30 wt % of a 1:1 mixture of pentaerythrityl-tetrakis(3-(3′,5′-di-tert. butyl-4-hydroxyphenyl)-propionate from BASF and Tris (2,4-di-t-butylphenyl) phosphite from BASF.

TABLE 2
Properties of mixed-plastic polypropylene blends

| | | B-ELV1 | B-ELV2 | B-PCR3 |
|---|---|---|---|---|
| MFR₂ | [g/10 min] | 10 | 10 | 25 |
| C2(total) | [wt.-%] | 23 | 22 | 5.4 |
| iV | [dL/g] | 1.66 | 1.91 | 1.56 |
| SF | [wt.-%] | 34 | 25 | 11 |
| C2(SF) | [wt.-%] | 50 | 44 | 27.7 |
| iV(SF) | [dL/g] | 1.75 | 2.35 | 1.71 |
| CF | [wt.-%] | 66 | 75 | 89 |
| C2(CF) | [wt.-%] | 10 | 16 | 27.7 |
| iV(CF) | [dL/g] | 1.63 | 1.79 | 1.55 |
| Density | [g/cm³] | 1.02 | 0.92 | 0.917 |
| Talc content | [wt.-%] | 15 | 6 | 1.5 |
| inclusions | | present | present | n.d. |
| attributed to | | | | |
| automotive paints | | | | |
| Limonene content | [mg/m³ | n.d. | n.d. | 12 |
| | in air] | | | |
| Acetic acid | [mg/m³ | 15 | 16 | n.d. |
| | in air] | | | |
| Acetaldehyde | [mg/m³ | 20 | 24 | n.d. |
| | in air] | | | |
| Flexural modulus | [MPa] | 1587 | 1030 | 1344 |
| Charpy NIS, +23 °C | [kJ/m²] | 34 | 39 | 5.14 |

n.d. = not detectable, below the detection limit

### 2.3 Compounding of Inventive and Comparative Compositions

The inventive and comparative compositions were prepared based on the recipes indicated in Table 3 by compounding in a co-rotating twin-screw extruder Coperion ZSK 40 at 220 °C.

In addition to the HECOs and the mixed-plastic polypropylene blends described above, the following commercially available components were also employed:

| | |
|---|---|
| EC | an elastomeric ethylene-1-octene copolymer with a trade name of Engage |
| | 8180, commercially available from Dow Chemicals (USA), having an MFR2 |
| | (190 °C) of 0.5 g/10 min and a density of 863 kg/m³. |
| F | talc with a trade name of Jetfine 3CA, commercially available from Imerys |
| | (France), with median diameter d50 of 3.9 μm and top cut diameter d95 of |
| | 7.8 μm. |
| Black MB | a polyethylene based masterbatch CBMB LD-09 A02 from Borealis AG |
| | (Norway). It contains 40 wt.-% of pigment. |
| White MB | a polyethylene based masterbatch Masterminds PE white 90/1111 from |
| | QolorTech (The Netherlands). It contains 70 wt.-% of pigment. |
| Additives MB | an additive masterbatch, consisting of 2.40 wt.-% of a carrier propylene |
| | homopolymer with a trade name of HC001 A, commercially available from |
| | Borealis AG (Austria), 0.10 wt.-% of an antioxidant with a trade name of |
| | Irgafos 168 (CAS-no. 31570-04-4), available from BASF AG (Germany), |
| | 0.25 wt.-% of an antioxidant with a trade name of Irganox 1076 (CAS-no. |
| | 2082-79-3), commercially available from BASF AG (Germany), 0.30 wt.-% |
| | of bisphenol A-epoxy resin with a trade name of Araldite GT 7072 ES |
| | (CAS-no. 25036-25-3), commercially available from Huntsman Corporation |
| | (USA), 1.70 wt.-% of silicon masterbatch i.e. dimethyl |
| | siloxane:polypropylene = 50:50 from Dow Corning. 0.20 wt.-% of a UV- |
| | stabiliser masterbatch with a trade name of Cyasorb UV-3808PP5, |
| | commercially available from Cytec Industries, Inc. (USA), and 0.20 wt.-% |
| | of a slip agent with a trade name of Crodamide EBS beads (CAS-no. 203- |
| | 755-6), commercially available from Croda International (UK). |

The properties of the inventive and comparative compositions CE1, IE1 and IE3 are given in Table 4.

TABLE 3
Recipes for inventive and comparative examples

| | | CE1 | IE1 | IE2 | IE3 | IE4 | CE2 | IE5 |
|---|---|---|---|---|---|---|---|---|
| HECO1 | [wt.-%] | 18.85 | 24.85 | 18.85 | 22.06 | 13.85 | 30.03 | 32.16 |
| HECO2 | [wt.-%] | 17.00 | 22.41 | 17.00 | 19.90 | 15.00 | 27.08 | 29.00 |
| B-ELV1 | [wt.-%] | — | — | — | 30.00 | 47.00 | — | — |
| B-ELV2 | [wt.-%] | — | 30.00 | 46.00 | — | — | — | 10.00 |
| B-PCR3 | [wt.-%] | 30.00 | — | — | — | — | 10.00 | — |
| EC | [wt.-%] | 10.00 | 2.50 | — | 5.10 | 3.00 | 8.15 | 5.60 |
| F | [wt.-%] | 15.00 | 11.09 | 9.00 | 13.79 | 12.00 | 15.59 | 14.09 |
| Black MB | [wt.-%] | 2.60 | 2.60 | 2.60 | 2.60 | 2.60 | 2.60 | 2.60 |
| White MB | [wt.-%] | 1.40 | 1.40 | 1.40 | 1.40 | 1.40 | 1.40 | 1.40 |
| Additives | [wt.-%] | 5.15 | 5.15 | 5.15 | 5.15 | 5.15 | 5.15 | 5.15 |
| MB | | | | | | | | |
| | CE3 | IE6 | IE7 | CE4 | IE8 | CE5 | IE9 | |
| HECO1 | 6.45 | 17.23 | 27.53 | 25.58 | 32.00 | 12.54 | 19.06 | |
| HECO2 | 5.82 | 15.54 | 24.82 | 23.07 | 28.85 | 11.31 | 17.19 | |
| B-ELV1 | — | — | — | — | — | — | — | |
| B-ELV2 | — | 50.00 | 23.00 | — | 30.00 | — | 30.00 | |
| B-PCR3 | 50.00 | — | — | 30.00 | — | 30.00 | — | |
| EC | 13.00 | — | 3.50 | 7.70 | — | 12.50 | 4.60 | |
| F | 15.58 | 8.08 | 12.00 | 4.50 | — | 24.50 | 20.00 | |
| Black MB | 2.60 | 2.60 | 2.60 | 2.60 | 2.60 | 2.60 | 2.60 | |
| White MB | 1.40 | 1.40 | 1.40 | 1.40 | 1.40 | 1.40 | 1.40 | |
| Additives | 5.15 | 5.15 | 5.15 | 5.15 | 5.15 | 5.15 | 5.15 | |
| MB | | | | | | | | |

TABLE 4
Properties of the inventive and comparative compositions

| | | CE1 | IE1 | IE2 | IE3 | IE4 | CE2 | IE5 |
|---|---|---|---|---|---|---|---|---|
| MFR2 | [g/10 | 13.2 | 19.7 | 13.4 | 10.6 | 9.6 | 14.8 | 14.8 |
| | min] | | | | | | | |
| C2(total) | [wt.-%] | 17.2 | 13.8 | 14.6 | 18.1 | 17.4 | 16.5 | 15.8 |
| iV(total) | [dL/g] | 1.81 | 1.72 | 1.79 | 1.92 | 1.93 | 1.91 | 1.88 |
| SF | [wt.-%] | 23.9 | 20.3 | 26.2 | 25.5 | 25.0 | 25.4 | 26.2 |
| C2(SF) | [wt.-%] | 53.0 | 37.0 | 31.4 | 48.7 | 36.0 | 50.0 | 47.1 |
| iV(SF) | [dL/g] | 2.43 | 2.44 | 2.17 | 2.67 | 2.43 | 2.85 | 2.78 |
| CF | [wt.-%] | 76.1 | 79.7 | 73.8 | 74.5 | 75.0 | 74.6 | 73.8 |
| C2(CF) | [wt.-%] | 6.2 | 7.1 | 8.5 | 8.4 | 12.1 | 5.0 | 3.8 |
| iV(CF) | [dL/g] | 1.57 | 1.49 | 1.66 | 1.63 | 1.76 | 1.55 | 1.55 |
| inclusions | [—] | n.d. | present | present | present | present | n.d. | present |
| attributed to | | | | | | | | |
| automotive | | | | | | | | |
| paints | | | | | | | | |
| Limonene | [mg/m³ | | n.d. | n.d. | n.d. | n.d. | | n.d. |
| content | in air] | | | | | | | |
| Acetic acid | [mg/m³ | | | n.d. | | n.d. | | |
| | in air] | | | | | | | |
| Acetaldehyde | [mg/m³ | | | 30 | | 34 | | |
| | in air] | | | | | | | |
| Acetone | [mg/m³ | | | 64 | | 99 | | |
| | in air] | | | | | | | |
| Ash | [wt.-%] | 14.8 | 15.4 | 15.9 | 15.6 | 14.8 | 15.6 | 15.6 |
| Flexural | [MPa] | 1830 | 1786 | 1915 | 1778 | 1535 | 1945 | 1854 |
| Modulus | | | | | | | | |
| Charpy NIS | [kJ/m²] | 20.9 | 17.1 | 21.0 | 31.8 | 36.7 | 19.2 | 23.9 |
| (+23 °C) | | | | | | | | |
| Charpy NIS | [kJ/m²] | 4.1 | 3.9 | 3.7 | 4.9 | 4.7 | 4.1 | 4.1 |
| (−20 °C) | | | | | | | | |
| Puncture | [J] | 8.6 | 4.6 | 4.6 | 3.9 | 3.6 | 16.5 | 3.7 |
| energy | | | | | | | | |
| (−30 °C) | | | | | | | | |
| Average | [—] | 107.0 | 108.0 | 97.2 | 105.7 | 109.3 | 105.1 | 105.9 |
| CTLE | | | | | | | | |
| (+23/80 °C) | | | | | | | | |
| Average | [—] | 85.6 | 88.3 | 78.8 | 85.3 | 89.3 | 84.4 | 86.4 |
| CTLE | | | | | | | | |
| (−30/80 °C) | | | | | | | | |
| Scratch | [—] | 0.69 | −0.15 | 0.60 | 0.28 | 0.20 | 0.41 | 0.61 |
| resistance | | | | | | | | |
| (10N) | | | | | | | | |
| Shrinkage in | [%] | 0.87 | 0.87 | | 0.85 | | 0.87 | 0.82 |
| flow | | | | | | | | |
| Shrinkage | [%] | 1.05 | 1.07 | | 1.03 | | 1.06 | 1.01 |
| cross flow | | | | | | | | |
| Average | [%] | 0.96 | 0.97 | | 0.94 | | 0.97 | 0.92 |
| shrinkage | | | | | | | | |
| LBS | [μg/g] | 11 | 38 | 29 | 13 | 30 | 11 | 29 |
| HBS | [μg/g] | 93 | 186 | 216 | 99 | 189 | 79 | 139 |
| Fogging | [mg] | 0.22 | 0.59 | 0.59 | 0.17 | 0.64 | 0.13 | 0.37 |

| | CE3 | IE6 | IE7 | CE4 | IE8 | CE5 | IE9 |
|---|---|---|---|---|---|---|---|
| MFR2 | 12.8 | 14.9 | 16.8 | 16.3 | 20.9 | 11.8 | 12.8 |
| C2(total) | 20.5 | 15.7 | 13.6 | 15.5 | 11.4 | 21.3 | 15.3 |
| iV(total) | 1.73 | 1.73 | 1.78 | 1.84 | 1.84 | 1.78 | 1.75 |
| SF | 26.0 | 22.9 | 21.9 | 23.8 | 20.5 | 28.5 | 22.6 |
| C2(SF) | 60.7 | 40.0 | 38.4 | 52.2 | 35.0 | 61.2 | 41.8 |
| iV(SF) | 2.05 | 2.39 | 2.54 | 2.59 | 2.92 | 2.24 | 2.41 |
| CF | 74.0 | 77.1 | 78.1 | 76.2 | 79.5 | 71.5 | 77.4 |
| C2(CF) | 6.4 | 7.6 | 5.5 | 4.6 | 5.4 | 6.6 | 7.6 |
| iV(CF) | 1.58 | 1.53 | 1.52 | 1.57 | 1.55 | 1.54 | 1.52 |
| inclusions | n.d. | present | present | n.d. | present | n.d. | present |
| attributed to | | | | | | | |
| automotive | | | | | | | |
| paints | | | | | | | |
| Limonene | | n.d. | n.d. | 0.99 | n.d. | | n.d. |
| content | | | | | | | |
| Acetic acid | | | | | | | |
| Acetaldehyde | | | | | | | |
| Acetone | | | | | | | |
| Ash | 15.6 | 15.6 | 15.5 | 4.5 | 4.5 | 24.5 | 24.3 |
| Flexural | 1738 | 1854 | 1849 | 1322 | 1278 | 2177 | 2231 |
| Modulus | | | | | | | |
| Charpy NIS | 35.2 | 23.9 | 14.9 | 14.4 | 11.9 | 40.4 | 24.3 |
| (+23 °C) | | | | | | | |
| Charpy NIS | 4.2 | 4.1 | 3.9 | 4.6 | 4.0 | 3.9 | 2.7 |
| (−20 °C) | | | | | | | |
| Puncture | 13.5 | 3.7 | 3.2 | 13.6 | 2.7 | 15.4 | 1.9 |
| energy | | | | | | | |
| (−30 °C) | | | | | | | |
| Average | 108.4 | 105.9 | 107.2 | 133.2 | 132.5 | 92.4 | 92.8 |
| CTLE | | | | | | | |
| (+23/80 °C) | | | | | | | |
| Average | 86.5 | 86.4 | 87.6 | 108.1 | 109.8 | 73.7 | 75.3 |
| CTLE | | | | | | | |
| (−30/80 °C) | | | | | | | |
| Scratch | 0.43 | 0.61 | 0.36 | 0.00 | 0.54 | 2.28 | 1.52 |
| resistance | | | | | | | |
| (10N) | | | | | | | |
| Shrinkage in | 0.81 | 0.82 | 0.87 | 1.19 | 1.26 | 0.64 | 0.66 |
| flow | | | | | | | |
| Shrinkage | 0.99 | 1.01 | 1.07 | 1.39 | 1.51 | 0.81 | 0.84 |
| cross flow | | | | | | | |
| Average | 0.90 | 0.92 | 0.97 | 1.29 | 1.39 | 0.73 | 0.75 |
| shrinkage | | | | | | | |
| LBS | 1 | 29 | 49 | 31 | 36 | 11 | 35 |
| HBS | 59 | 139 | 271 | 163 | 190 | 82 | 205 |
| Fogging | 0.23 | 0.37 | 0.69 | 0.41 | 0.48 | 0.13 | 0.38 |

n.d. = not detectable, below the detection limit

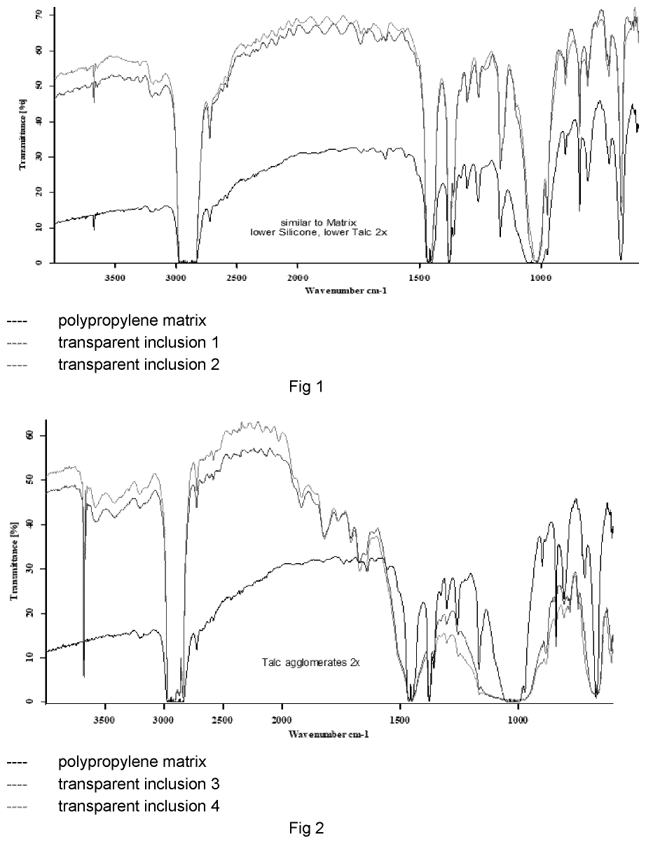

FIGS. 1-5 show examples for IR spectra from exemplary inclusions selected from compressed films having a thickness of about 70 μm prepared from the compositions of examples CE1, IE3, IE7 and IE8.

In FIG. 1 the spectra of the polypropylene composition matrix of CE1 and two transparent inclusions (inclusions 1 and 2) are shown. The spectra show comparable peaks so that the two transparent inclusions are identified as inclusions, which are composed of the polypropylene composition which differs from the matrix in a lower silicone content and lower talc content.

In FIG. 2 the spectra of the polypropylene composition matrix of CE1 and two different transparent inclusions (inclusions 3 and 4) are shown. From the spectra the two transparent inclusions are identified as talc agglomerates.

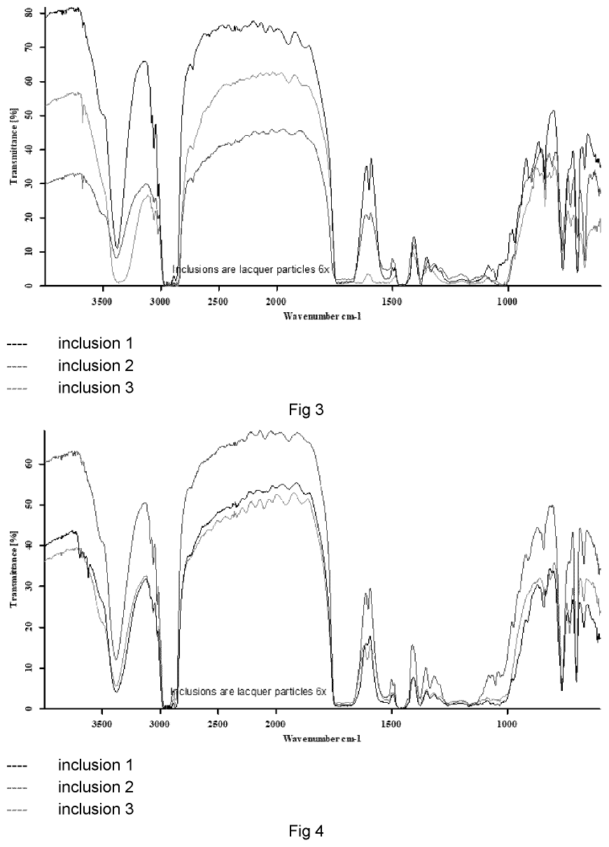

In FIG. 3 the spectra three inclusions of IE3 are shown. The spectra all show distinct bands at about 700 cm⁻¹ and about 760 cm⁻¹, which can be attributed to styrene modifications, further bands at about 3380 cm⁻¹, which can be attributed to OH, NH stretching of acrylate or urethane, and at about 1700 cm⁻¹, which can be attributed to C═O stretching of acrylate or urethane. These bands are identified as markers for automotive paints.

In FIG. 4 the spectra of three inclusions of IE7 are shown. The spectra all show distinct bands at about 700 cm⁻¹ and about 760 cm⁻¹, which can be attributed to styrene modifications, further bands at about 3380 cm⁻¹, which can be attributed to OH, NH stretching of acrylate or urethane, and at about 1700 cm⁻¹, which can be attributed to C═O stretching of acrylate or urethane. These bands are identified as markers for automotive paints.

In FIG. 5 the spectra of three inclusions of IE8 are shown. The spectra all show distinct bands at about 700 cm⁻¹ and about 760 cm⁻¹, which can be attributed to styrene modifications, further bands at about 3380 cm⁻¹, which can be attributed to OH, NH stretching of acrylate or urethane, and at about 1700 cm⁻¹, which can be attributed to C═O stretching of acrylate or urethane. These bands are identified as markers for automotive paints.

Summarizing, FIGS. 1 and 2 show IR spectra of comparative inclusions, whereas FIG. 3-5 show IR spectra of inclusions of interest.

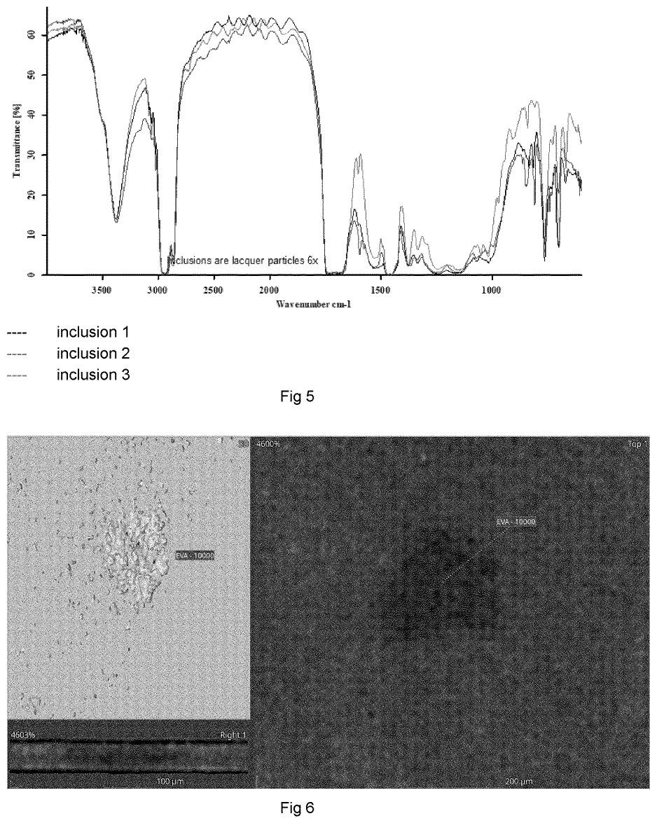

FIGS. 6-12 show examples for CT pictures of exemplary inclusions selected from compressed films having a thickness of about 70 μm prepared from the compositions of examples CE5, CE4, IE6, IE7 and IE8.

FIG. 6 shows an inclusion of example CE5 with an irregular round 3D shape, which has been identified as an ethylene-vinylacetate (EVA) particle.

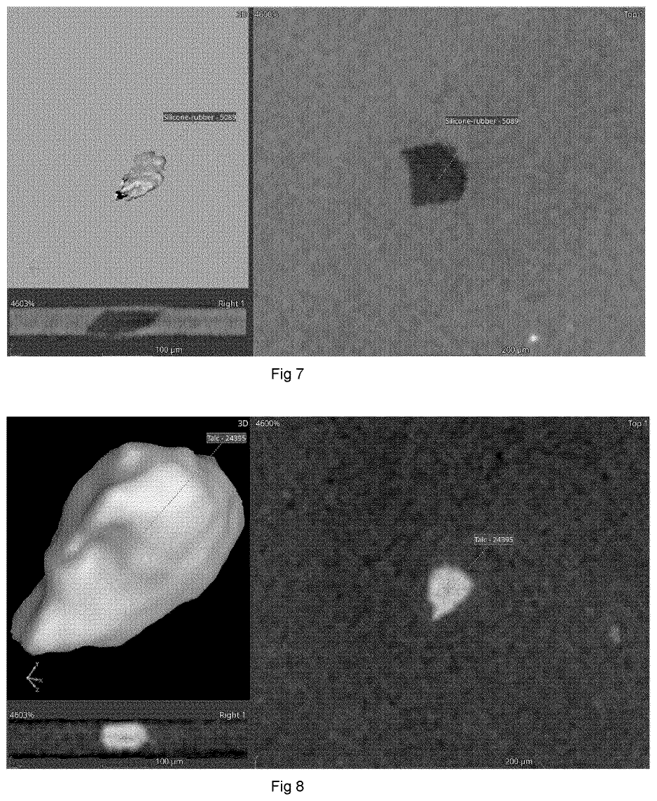

FIG. 7 shows an inclusion of example CE5 with an irregular round 3D shape, which has been identified as a silicone rubber particle.

FIG. 8 shows an inclusion of example CE4 with a round shape, which has been identified as talc particle.

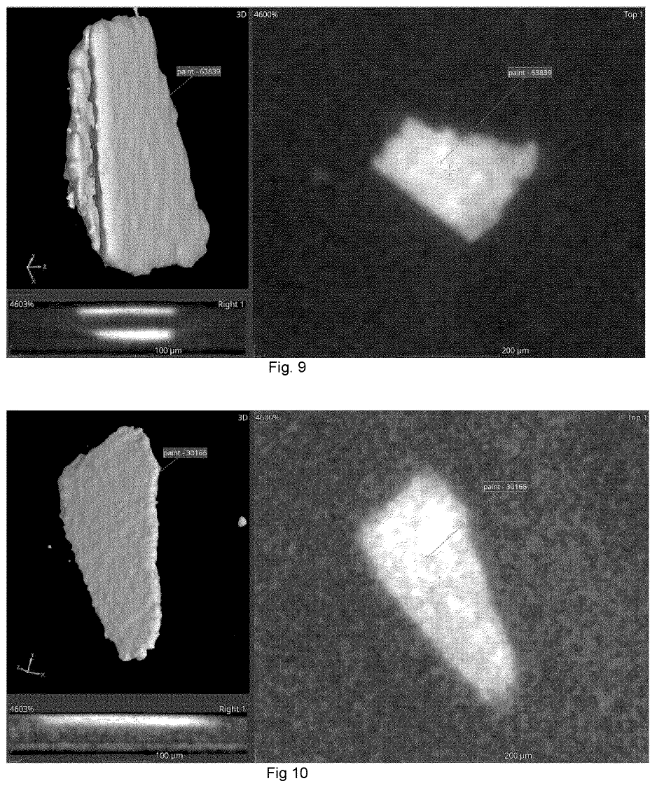

FIG. 9 shows an inclusion of example IE6 with a multilayer sharp edged and platelet-like 3D shape and has been identified as paint particle.

FIG. 10 shows a second inclusion of example IE6 with a sharp edged and platelet-like 3D shape and has been identified as paint particle.

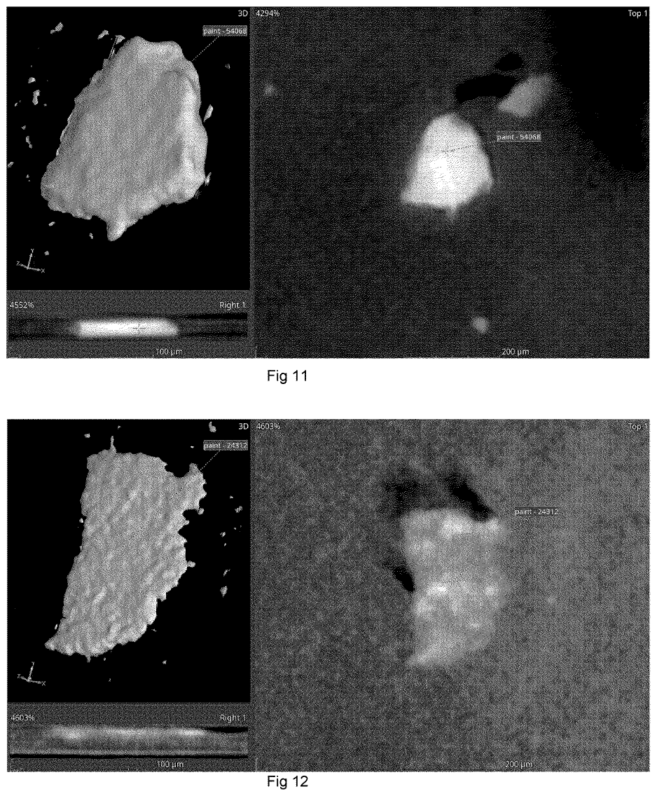

FIG. 11 shows an inclusion of example IE7 with a sharp edged and platelet-like 3D shape and has been identified as paint particle.

FIG. 12 shows an inclusion of example IE8 with a sharp edged and platelet-like 3D shape and has been identified as paint particle.

Summarizing, FIG. 6-8 show CT pictures of comparative inclusions, whereas FIG. 39-12 show CT pictures of inclusions of interest.

The compositions have been prepared as such that several inventive compositions comprising an ELV mixed plastics polypropylene blend can be directly compared to several comparative compositions comprising a PCR mixed plastics polypropylene blend.

The following compositions can be directly compared:
CE1, IE1 and IE3 (in addition IE2 and IE4 with the same general composition obtained with higher amounts of ELV mixed plastics polypropylene blend of about 45 wt.-% and IE7 with the same general composition obtained with a lower amount of ELV mixed plastics polypropylene blend of 23 wt.-%)
CE2 and IE5 with the same general composition as CE1, IE1 and IE3 with an amount of ELV mixed plastics polypropylene blend of 10 wt.-%
CE3 and IE6 with the same general composition as CE1, IE1 and IE3 with an amount of ELV mixed plastics polypropylene blend of 50 wt.-%
CE4 and IE8 with a low overall amount of inorganic filler (4.5 wt.-% ash content)
CE5 and IE9 with a high overall amount of inorganic filler (24.5 wt.-% ash content)

It can be seen that a comparable balance of properties can be obtained for the different comparable blends whereby, a lower amount of virgin elastomer (EC) and a lower amount of virgin inorganic filler (F) is used.

The inventive compositions thereby tend towards improved scratch resistance, at comparable stiffness, impact properties, shrinkage and CTLE properties. On the other hand, the inventive compositions also tend to show a lower puncture energy and higher emissions.

1. A polypropylene composition (PC) being a mixed-plastic polypropylene blend, suitable for automotive interior applications, wherein the polypropylene composition (PC) comprises:
inclusions attributed to automotive paints, determined on compressed films with a thickness of 35 to 70 μm, wherein the inclusions are identified by optical microscopy, the chemical composition of the inclusions are characterized by infrared spectroscopy and the physical information of the inclusions is characterized by computed tomography; and
a content of low boiling organic substances (LBS), determined by screening of organic emissions by thermos-desorption analysis of not more than 100 μg/g;
wherein the polymeric part of said polypropylene composition (PC) has:
i) an ethylene content (C2(total)), determined from crystallization extraction (CRYSTEX) by FT-IR spectroscopy calibrated by quantitative ¹³C-NMR spectroscopy, in the range from 7.5 to 35.0 wt. %;
ii) a crystalline fraction (CF) content, determined by crystallization extraction (CRYSTEX) analysis, in the range from 60.0 to 80.0 wt. %,
said crystalline fraction (CF) having an ethylene content (C2(CF)), determined by FT-IR spectroscopy calibrated by quantitative ¹³C-NMR spectroscopy, in the range from 1.0 to 15.0 wt. %, and
an intrinsic viscosity (iV(CF)), determined according to DIN ISO 1628/1, in the range from 1.00 to 2.00 dL/g; and
iii) a soluble fraction (SF) content, determined by crystallization extraction (CRYSTEX) analysis, in the range from 20.0 to 40.0 wt. %,
said soluble fraction (SF) having
an intrinsic viscosity (iV(SF)), determined according to DIN ISO 1628/1, in the range from 1.80 to 3.60 dL/g.

2. The polypropylene composition (PC) according to claim 1, having one or more or all of the following properties:
a limonene content, determined by solid phase microextraction (HS-SPME-GC-MS), of not more than 5.0 ppm;
a content of high boiling organic substances (HBS), determined by screening of organic emissions by thermo-desorption analysis, in the range from 10 to 300 μg/g; and
an amount of fogging, determined according to the gravimetric method DI 75201:2011-11, method B, in the range from 0.05 to 1.00 mg.

3. The polypropylene composition (PC) according claim 1, having at least one or more or all, of the following properties:
an ethylene content of the soluble fraction (C2(SF)), determined from crystallization extraction (CRYSTEX) by FT-IR spectroscopy calibrated by quantitative ¹³C-NMR spectroscopy, in the range from 25.0 to 70.0 wt. %;
a melt flow rate (MFR₂), determined according to ISO 1133 at 230 °C and 2.16 kg, in the range from 5.0 to 50.0 g/10 min;
a flexural modulus, determined according to ISO 178 using 80×10×4 mm³ test bars injection-moulded in line with ISO 19069-2, in the range from 900 to 2500 MPa;
a Charpy Notched impact strength at 23 °C, determined according to ISO 179 using 80×10×4 mm³ test bars injection-moulded in line with ISO 19069-2, in the range from 10.0 to 70.0 kJ/m²; and
a Charpy Notched impact strength at −20 °C, determined according to ISO 179 using 80×10×4 mm³ test bars injection-moulded in line with ISO 19069-2, in the range from 2.5 to 12.0 kJ/m².

4. The polypropylene composition (PC) according to claim 1 comprising:
a) from 5.0 to 65.0 wt. % of heterophasic propylene-ethylene copolymer (HECO);
b) from 7.5 to 85.0 wt. % of a mixed-plastic polypropylene blend (B) comprising inclusions attributed to automotive paints;
c) from 0 to 7.5 wt. % of ethylene-1-octene elastomer (EC);
d) from 0 to 25.0 wt. % of an inorganic filler (F);
e) from 0.5 to 10.0 wt. % of a pigment masterbatch (P), which comprises one or more pigments, wherein the total pigment content is in the range from 40.0 to 80.0 wt. %, relative to the total weight of the pigment masterbatch (P); and
f) from 0.2 to 5.0 wt. % of further additives (A),
wherein the total contents of components a) to f) add up to at least 95 wt. % relative to the total weight of the polypropylene composition (PC).

5. The polypropylene composition (PC) according to claim 1, being obtainable by blending at least components a) to h):
a) from 1.0 to 40.0 wt. %, relative to the total weight of the polypropylene composition (PC), of a first heterophasic propylene-ethylene copolymer (HECO1), having a melt flow rate (MFR₂), determined according to ISO 1133 at 230 °C and 2.16 kg, in the range from 90 to 250 g/10 min and an intrinsic viscosity, determined according to DIN ISO 1628/1, of the soluble fraction (iV(SF)), according to crystallization extraction (CRYSTEX) analysis, in the range from 2.00 to 4.00 dL/g;
b) from 0 to 35.0 wt. %, relative to the total weight of the of the polypropylene composition (PC), of a second heterophasic propylene-ethylene copolymer (HECO2), having a melt flow rate (MFR₂), determined according to ISO 1133 at 230 °C and 2.16 kg, in the range from 3.0 to 30 g/10 min and an intrinsic viscosity, determined according to DIN ISO 1628/1, of the soluble fraction (iV(SF)), according to crystallization extraction (CRYSTEX) analysis, in the range from 4.10 to 10.00 dL/g;
c) from 0 to 35.0 wt. %, relative to the total weight of the polypropylene composition (PC), of a third heterophasic propylene-ethylene copolymer (HECO3), having a melt flow rate (MFR₂), determined according to ISO 1133 at 230 °C and 2.16 kg, in the range from 5.0 to 30 g/10 min and an intrinsic viscosity, determined according to DIN ISO 1628/1, of the soluble fraction (iV(SF)), according to crystallization extraction (CRYSTEX) analysis, in the range from 2.00 to 4.00 dL/g;
d) from 7.5 to 85.0 wt. %, relative to the total weight of the polypropylene composition (PC), of a mixed-plastic polypropylene blend (B) comprising inclusions attributed to automotive paints, determined on compressed films with a thickness of 35 to 70 μm, wherein the inclusions are identified by optical microscopy, the chemical composition of the inclusions are characterized by infrared spectroscopy and the physical information of the inclusions is characterized by computed tomography;
e) from 0 to 7.5 wt. % of an ethylene-1-octene elastomer (EC);
f) from 0 to 25.0 wt. % of an inorganic filler (F);
g) from 0.5 to 10.0 wt. % of a pigment masterbatch (P), which comprises one or more pigments, wherein the total pigment content is in the range from 40.0 to 80.0 wt. %, relative to the total weight of the pigment masterbatch (P); and
h) from 0.2 to 5.0 wt. % of further additives (A);
wherein the total contents of components a) to h) add up to at least 95 wt. %, relative to the total weight of the polypropylene composition (PC).

6. The polypropylene composition (PC) according to claim 5, wherein the ethylene-1-octene elastomer (EC) has a melt flow rate (MFR₂), determined according to ISO 1133 at 190 °C and 2.16 kg, in the range from 0.2 to 2.5 g/10 min and/or a density, determined according to ISO 1183-187, in the range from 850 to 870 kg/m³.

7. The polypropylene composition (PC) according to claim 5, wherein the filler is talc having a median particle size d₅₀ before compounding in the range from 1.0 to 15.0 μm and/or a top-cut particle size d₉₅ before compounding in the range from 2.0 to 30.0 μm.

8. The polypropylene composition (PC) according to claim 5, wherein the first heterophasic propylene-ethylene copolymer (HECO1) has:
a soluble fraction (SF) content, determined according to crystallization extraction (CRYSTEX) analysis, in the range from 8.0 to 19.5 wt. %; and/or
an ethylene content of the soluble fraction (C2(SF)), according to crystallization extraction (CRYSTEX) analysis, determined by FT-IR spectroscopy calibrated by quantitative ¹³C-NMR spectroscopy, in the range from 31 to 45 wt. %.

9. The polypropylene composition (PC) according to claim 5, wherein the second heterophasic propylene-ethylene copolymer (HECO2) has:
a soluble fraction (SF) content, determined according to crystallization extraction (CRYSTEX) analysis, in the range from 20.0 to 40.0 wt. %; and/or
an ethylene content of the soluble fraction (C2(SF)), according to crystallization extraction (CRYSTEX) analysis, determined by FT-IR spectroscopy calibrated by quantitative ¹³C-NMR spectroscopy, in the range from 18 to 30 wt. %.

10. The polypropylene composition (PC) according to claim 5, wherein the third heterophasic propylene-ethylene copolymer (HECO3) has:
a soluble fraction (SF) content, determined according to crystallization extraction (CRYSTEX) analysis, in the range from 20.0 to 40.0 wt. %; and/or
an ethylene content of the soluble fraction (C2(SF)), according to crystallization extraction (CRYSTEX) analysis, determined by FT-IR spectroscopy calibrated by quantitative ¹³C-NMR spectroscopy, in the range from 31 to 45 wt. %.

11. The polypropylene composition (PC) according to claim 5, wherein the mixed-plastic polypropylene blend (B) has:
a melt flow (MFR₂), determined according to ISO 1133 at 230 °C and 2.16 kg, in the range from 5.0 to 30.0 g/10 min;
a soluble fraction (SF) content in the range from 10.0 to 50.0 wt. % and a crystalline fraction (CF) of the polymeric part of the mixed-plastic polypropylene blend (B) in the range from 50.0 to 90.0 wt. %, both determined according to crystallization extraction (CRYSTEX) analysis;
an ethylene content of the crystalline fraction (C2(CF)), according to crystallization extraction (CRYSTEX) analysis, determined by FT-IR spectroscopy calibrated by quantitative ¹³C-NMR spectroscopy, in the range from 5.0 to 25.0 wt. %;
an intrinsic viscosity of the crystalline fraction (iV(CF)), according to crystallization extraction (CRYSTEX) analysis, determined according to DIN ISO 1628/1, in the range from 0.90 to 2.10 dL/g;
an ethylene content of the soluble fraction (C2(SF)), according to crystallization extraction (CRYSTEX) analysis, determined by FT-IR spectroscopy calibrated by quantitative ¹³C-NMR spectroscopy, in the range from 30.0 to 60.0 wt. %;
an intrinsic viscosity of the soluble fraction (iV(SF)), according to crystallization extraction (CRYSTEX) analysis, determined according to DIN ISO 1628/1, in the range from 1.10 to 2.75 dL/g;
a total ethylene content in the range from 15.0 to 30.0 wt. %, determined by FT-IR spectroscopy calibrated by quantitative ¹³C-NMR spectroscopy;
an intrinsic viscosity (IV), determined according to DIN ISO 1628/1, in the range from 1.25 to 2.25 dL/g
an inorganic residue content, as determined by calcination analysis according to DIN ISO 1172:1996, of 0.5 to 10.0 wt. %;
a limonene content, determined by solid phase microextraction (HS-SPME-GC-MS), of not more than 10.0 ppm; and
a content of derivatives from organic acids and/or organic aldehydes, of 1 to 100 ppm.

12. The polypropylene composition (PC) according to claim 5, wherein the mixed-plastic polypropylene blend (B) comprises from 2.5 to 30 wt. % inorganic filler, relative to the total weight of the mixed-plastic polypropylene blend (B).

13. The polypropylene composition (PC) according to claim 5, wherein the mixed-plastic polypropylene blend (B) originates from end-of life vehicle (ELV) recycled feedstock.

14. An article comprising the polypropylene composition according to claim 1 in an amount of at least 95 wt. %.

15. The article according to claim 14, having one or more or all of the following properties:
a scratch resistance at 10 N in the range from −0.20 to 1.00;
an average coefficient of linear thermal expansion at a temperature range from +23 to +80 °C at a heating rate of 1 °C/min in machine direction (average CLTE 23-80 °C) of below 150 μm/m °C, such as not more than 140 μm/m °C;
an average coefficient of linear thermal expansion at a temperature range from −30 to +80 °C at a heating rate of 1 °C/min in machine direction (average CLTE −30-80 °C) of below 120 μm/m °C;
an isotropic area shrinkage of not more than 1.50% determined on injection moulded samples.

16. The polypropylene composition (PC) according to claim 4, wherein the mixed-plastic polypropylene blend (B) has:
a melt flow (MFR₂), determined according to ISO 1133 at 230 °C and 2.16 kg, in the range from 5.0 to 30.0 g/10 min;
a soluble fraction (SF) content in the range from 10.0 to 50.0 wt. % and a crystalline fraction (CF) of the polymeric part of the mixed-plastic polypropylene blend (B) in the range from 50.0 to 90.0 wt. %, both determined according to crystallization extraction (CRYSTEX) analysis;
an ethylene content of the crystalline fraction (C2(CF)), according to crystallization extraction (CRYSTEX) analysis, determined by FT-IR spectroscopy calibrated by quantitative ¹³C-NMR spectroscopy, in the range from 5.0 to 25.0 wt. %;
an intrinsic viscosity of the crystalline fraction (iV(CF)), according to crystallization extraction (CRYSTEX) analysis, determined according to DIN ISO 1628/1, in the range from 0.90 to 2.10 dL/g;
an ethylene content of the soluble fraction (C2(SF)), according to crystallization extraction (CRYSTEX) analysis, determined by FT-IR spectroscopy calibrated by quantitative ¹³C-NMR spectroscopy, in the range from 30.0 to 60.0 wt. %;
an intrinsic viscosity of the soluble fraction (iV(SF)), according to crystallization extraction (CRYSTEX) analysis, determined according to DIN ISO 1628/1, in the range from 1.10 to 2.75 dL/g;
a total ethylene content in the range from 15.0 to 30.0 wt. %, determined by FT-IR spectroscopy calibrated by quantitative ¹³C-NMR spectroscopy;
an intrinsic viscosity (iV), determined according to DIN ISO 1628/1, in the range from 1.25 to 2.25 dL/g
an inorganic residue content, as determined by calcination analysis according to DIN ISO 1172:1996, of 0.5 to 10.0 wt. %;
a limonene content, determined by solid phase microextraction (HS-SPME-GC-MS), of not more than 10.0 ppm; and
a content of derivatives from organic acids and/or organic aldehydes, of 1 to 100 ppm.

17. The polypropylene composition (PC) according to claim 4, wherein the mixed-plastic polypropylene blend (B) comprises from 2.5 to 30 wt. % inorganic filler, relative to the total weight of the mixed-plastic polypropylene blend (B).

18. The polypropylene composition (PC) according to claim 4, wherein the mixed-plastic polypropylene blend (B) originates from end-of life vehicle (ELV) recycled feedstock.
